(19) United States
(12) Patent Application Publication
(10) Pub. No.: US 2025/0269729 A1
(43) Pub. Date: Aug. 28, 2025

(54) Propulsion, Levitation, and Guidance Systems For Enhanced Efficiency and Reduced Drag in High-Speed Capsules Operating Under Low-Pressure Vacuum Conditions

(71) Applicant: HYPERLOOP TRANSPORTATION TECHNOLOGIES, INC., CULVER CITY, CA (US)

(72) Inventors: SOFIANE OUAGUED, Toulouse (FR); FRANCOIS-XAVIER FENET, Toulouse (FR)

(21) Appl. No.: 19/067,352

(22) Filed: Feb. 28, 2025

Related U.S. Application Data
(60) Provisional application No. 63/558,875, filed on Feb. 28, 2024.

(51) Int. Cl. B60L 13/06

(52) U.S. Cl. CPC B60L 13/06

(57) ABSTRACT

This invention discloses an integrated propulsion, guidance, and levitation system for a capsule in a partial vacuum tunnel. The bogie side features two opposing back irons, each with multipolar permanent magnets, forming an air-core linear synchronous motor. U-shaped electromagnets provide lateral guidance by interacting with a vertical ferromagnetic track. A hybrid active-passive levitation mechanism with homopolar magnets attached to an iron core interacts with a horizontal ferromagnetic track. On the track side, three-phase coils embedded in epoxy resin create a traveling electromagnetic field, propelling the bogie via synchronized magnet interactions. The coils, arranged in single-turn or segmented configurations, can be copper or aluminum. Track sections integrate lateral guidance and levitation beams in an L-shaped cross section for structural efficiency. The system's coils, magnets, and iron components are distributed to optimize power usage, stability, and high-speed travel performance.

### CROSS-REFERENCE TO RELATED APPLICATIONS

This application claims benefit of U.S. Provisional Application No. 63/558,875, filed Feb. 28, 2024, which is hereby incorporated herein by reference in its entirety.

### TECHNICAL FIELD

The present invention relates generally to the field of levitation and guidance for high-speed ground transportation. More specifically, the present invention is related to propulsion, levitation, and guidance systems for enhanced efficiency and reduced drag in high-speed capsules operating under low-pressure vacuum conditions.

### BACKGROUND OF THE INVENTION

The conveyance of people and materials directly influences the development of population centers and facilitates the connection between people, places, and materials. The predominant modes of transportation move across land, water, and air while requiring physical materials, economic resources, and societal oversight for integration into existing plans and infrastructure. Predominant modes of transportation create negative externalities, including degradation of the environment, contamination of intersecting ecosystems, harm to inhabitants' health, wasted time, increased inefficiency, and reduced standards of living. Each mode of transportation imposes a social choice onto residents that allocates affected land toward one purpose while preventing uses of the space that conflict with the specific needs of each mode.

Increasing the speeds for predominant modes of transportation solves some of the economic concerns for the predominant modes of transportation, but higher speeds create logistical obstacles for integrating these modes into cities and connecting corridors. These logistical concerns of higher-speed land transportation include the contiguity of land allocation, higher energy consumption, passenger safety, safe pedestrian and wildlife crossings, noise pollution, and higher costs.

Maglev transportation systems and tube-based low-pressure maglev systems, the so-called Hyperloop, enable a safe and low maintenance cost transportation system. The main challenge is to design a magnetic levitation and guidance system at a reasonable cost, with high performance.

Embodiments of the present invention are an improvement over prior art systems and methods.

### SUMMARY OF THE INVENTION

In one embodiment, the present invention provides a bogie side propulsion, guidance and levitation system comprising: (a) an air core linear synchronous motor comprising: (i) a first back iron with a first set of multipolar permanent magnets affixed to a backside of the first back iron; (ii) a second back iron with a second set of multipolar permanent magnets affixed to a backside of the second back iron; wherein the first back iron and the second back iron are attached to an underside of a bogie with the first set of multipolar magnets opposing the second set of multipolar magnets with an air gap formed in between them, and wherein polarity of permanent magnets in each opposing section of the first back iron and the second back iron is aligned in a similar direction to ensure proper magnetic flux orientation; (b) a lateral guidance system comprising a plurality of electromagnets, each of the plurality of electromagnets comprising a U-shaped metal core with each post in the U-shaped metal core having a coil wound thereon; (c) a hybrid active-passive levitation system comprising: (i) a plurality of homopolar permanent magnets; (ii) a iron core, wherein two parallel rows of homopolar permanent magnets are aligned along a direction of capsule movement, with all homopolar magnets within the same row maintain a similar polarity, while two opposing rows have opposite polarities, with a magnetic field flowing from one row to the other, passing through the air gap, an iron track, and the iron core.

In one embodiment, the bogie side propulsion, guidance and levitation system is implemented in a partial vacuum tunnel.

In one embodiment, either the first set of multipolar permanent magnets or the second set of multipolar permanent magnets, or a combination thereof, comprises Neodymium-Iron-Boron (NdFeB) magnets.

In one embodiment, either the first set of multipolar permanent magnets or the second set of multipolar permanent magnets, or a combination thereof, comprises Samarium-Cobalt (SmCo) magnets.

In one embodiment, the U-shaped metal core is a iron core.

In one embodiment, the coil wound on the U-shaped iron core is made from copper.

In one embodiment, the coil wound on the U-shaped iron core is made from Aluminum.

In one embodiment, a total number of the plurality of electromagnets is picked based on the mass of the capsule.

In one embodiment, the hybrid active-passive levitation system is embedded in epoxy resin.

In another embodiment, the present invention provides a track side propulsion, guidance, and levitation system comprising: (a) an air core linear synchronous motor stator comprising: (i) a plurality of three-phase coils, and (ii) an epoxy resin structure embedding the three-phase coils, wherein the three-phase coils are configured to generate a traveling electromagnetic field that interacts with a bogie-mounted set of multipolar permanent magnets to propel the vehicle; (b) a lateral guidance track portion comprising a first ferromagnetic track, wherein the first ferromagnetic track is configured to interact with a bogie-mounted plurality of electromagnets to provide lateral guidance; and (c) a levitation track portion comprising a second ferromagnetic beam arranged substantially horizontally, wherein the second ferromagnetic beam is configured to interact with a bogie-mounted hybrid active-passive levitation system to provide lift.

In one embodiment, the track side propulsion, guidance, and levitation system is implemented in a partial vacuum tunnel.

In one embodiment, the three-phase coils of the air core linear synchronous motor stator are arranged in a single-turn configuration to simplify manufacturing and reduce overall system cost.

In one embodiment, each of the plurality of three-phase coils of the air core linear synchronous motor stator is made from copper.

In one embodiment, each of the plurality of three-phase coils of the air core linear synchronous motor stator is made from aluminum.

In one embodiment, the lateral guidance track portion and the levitation track portion are integrated together to form an L-shaped cross section, simplifying the structural design.

In one embodiment, the first ferromagnetic track in the lateral guidance track portion and the second ferromagnetic track in the levitation track portion both comprise solid iron.

In one embodiment, the plurality of three-phase coils in the air core linear synchronous motor stator is distributed along a track in segments, each segment energizable independently based on a position of the capsule to optimize energy usage.

In one embodiment, the epoxy resin structure provides mechanical support and environmental protection to the plurality of three-phase coils, preserving precise coil positioning and mitigating vibrational effects during high-speed operation.

In yet another embodiment, the present invention provides a method of levitating, propelling, and guiding a capsule traveling along a track in at least a partial vacuum tunnel, the method comprising: (a) generating a propulsive force by supplying a three-phase current to a plurality of three-phase coils embedded in an epoxy resin structure on the track side, thereby creating a traveling electromagnetic field in an air core linear synchronous motor stator; (b) interacting the magnetic fields of the traveling electromagnetic field with at least a first set of multipolar permanent magnets and a second set of multipolar permanent magnets affixed to respective back irons on an underside of a bogie, wherein each set of multipolar permanent magnets opposes the other across an air gap, causing a propulsive force on the bogie; (c) providing lateral guidance by energizing a plurality of electromagnets on the bogie side, each of the plurality of electromagnets comprising a U-shaped metal core with a coil wound on each post, to induce electromagnetic attraction with a first ferromagnetic track portion arranged substantially vertically, thereby controlling lateral positioning of the capsule; (d) establishing hybrid active-passive levitation by arranging two parallel rows of homopolar permanent magnets of similar polarity within each row and opposite polarities between rows, wherein each row is affixed to an iron core on the bogie, and interacting said rows with a second ferromagnetic track portion arranged substantially horizontally, such that the weight of the capsule is supported by magnetic forces and selectively modulated by energizing one or more coils adjacent to the homopolar permanent magnets; and (e) maintaining air gaps between the bogie-mounted permanent magnets or electromagnets and the respective ferromagnetic track portions, wherein sensors monitor the air gaps, and a control system adjusts current in the three-phase coils or the electromagnet coils to ensure stable propulsion, guidance, and levitation throughout capsule travel.

### BRIEF DESCRIPTION OF FIGURES

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 illustrates an overview of the PLG (Propulsion, Levitation, and Guidance) systems integrated into the bogie of a tunnel-based capsule traversal system.

FIG. 2 illustrates the composition of a typical track in terms of active materials, showing where acceleration and deceleration coils are placed.

FIG. 3 illustrates a preliminary design of the PLG systems, highlighting main geometrical parameters and electromechanical characteristics.

FIG. 4 illustrates a continuation of the preliminary design, detailing masses and costs of active materials for the PLG systems.

FIG. 5 illustrates further aspects of the same preliminary design, focusing on the layout for a 36-ton capsule in a tunnel-based system.

FIG. 6 illustrates a calculation of vertical and lateral forces acting on the bogie under various operating conditions.

FIG. 7 illustrates a schematic of an optimal control strategy for regulating the levitation gap by adapting current in the control coils.

FIG. 8 illustrates the same control strategy in another view, showing how air-gap sensors feed data to the levitation control system.

FIG. 9 illustrates how the algorithm checks average control current, adjusting the air gap to maintain zero steady-state coil current whenever feasible.

FIG. 10 illustrates a modified bogie concept designed to enable track switching without moving parts on the track.

FIG. 11 illustrates a top view of the levitation track during a typical switching maneuver, showing duplicated tracks for routes 1 and 2.

FIG. 12 illustrates a simplified representation of the switching configuration when the bogie encounters missing track sections 1 and 3.

FIG. 13 illustrates the continuation of the switching process where track section 2 is missing, and the bogie still maintains levitation.

FIG. 14 illustrates a scenario with missing track section 1, ensuring levitation via the remaining tracks.

FIG. 15 illustrates a switching maneuver toward direction 2, simplifying the configuration similarly to FIGS. 12-14.

FIG. 16 illustrates another phase of the direction 2 switch, ensuring at least two levitation systems remain active.

FIG. 17 illustrates a further stage of the direction 2 switch, maintaining balanced levitation on both sides.

FIG. 18 illustrates a potential issue with attractive-only guidance forces when the capsule approaches the track for switching.

FIG. 19 illustrates a solution that replaces iron with a conductive non-ferromagnetic material, enabling repulsive forces.

FIG. 20 illustrates how reversing the polarity of the guidance coils achieves a combination of attraction and repulsion.

FIG. 21 illustrates an approach to mitigate drag caused by repulsive forces using a different track material or configuration.

FIG. 22 illustrates how Inductrack-type technology reduces drag force compared to a conventional conductive plate.

FIG. 23 illustrates an Electrodynamic Suspension (EDS) null flux arrangement providing lateral stabilization in both directions.

FIG. 24 illustrates the placement of Halbach arrays on the track to generate the necessary stabilizing forces for EDS.

FIG. 25 illustrates a solution relying on the capsule's centrifugal force for switching via curved track sections.

FIG. 26 illustrates placing permanent magnets on the track and air-core electromagnets on the bogie to create a controlled repulsive force during switching.

FIG. 27 illustrates the transition curve geometry used during curved track segments, with increasing curvature over distance.

FIG. 28 illustrates the equations for a spiral (clothoid) curve, which smoothly transitions the capsule into and out of curves.

FIG. 29 illustrates a front view of the bogie and guideway, marking key dimensions for switching analysis.

FIG. 30 illustrates a top view of the bogie and guideway, showing track alignment and geometric constraints.

FIG. 31 illustrates a typical scenario of moving solid objects (bogie) interacting with fixed ones (guideway, track) during switching.

FIG. 32 illustrates the discontinuities on the track when analyzing bogie shape and guideway parameters, indicating usable track portions.

FIG. 33 illustrates acceleration as a function of distance along the transition curve, using typical parameters for a tunnel-based capsule system.

FIG. 34 illustrates a front view of the capsule inside a tube and a 3D view of the capsule structure.

FIG. 35 illustrates the mechanical integration of the levitation system within the overall capsule and bogie.

FIG. 36 illustrates the mechanical integration of the guidance system, detailing the placement of electromagnets and track elements.

FIG. 37 illustrates the active components of a hybrid levitation system, showing permanent magnets, coils, and the iron track.

FIG. 38A illustrates a front view of the levitation pad with permanent magnets, iron core, and nominal air gap.

FIG. 38B illustrates optimization results for magnet dimensions and coil current effort, highlighting optimal configurations.

FIG. 38C illustrates how magnet height impacts both levitation mass and drag losses, guiding design trade-offs.

FIG. 39A illustrates the combination of solid and laminated iron parts used to reduce losses while maintaining mechanical integrity.

FIG. 39B illustrates the U-shaped laminated iron portion secured between solid iron parts in the levitation module.

FIG. 40 illustrates two adjacent levitation pads designed to ensure magnetic continuity and reduce end effects.

FIG. 41A illustrates how eddy currents form due to the end effect and how grooves can facilitate current cancellation.

FIG. 41B illustrates the specific dimensions of grooves introduced in the track to reduce eddy current loops.

FIG. 42 illustrates a magnet orientation approach, similar to a Halbach array, for smoothing field transitions and reducing losses.

FIG. 43A illustrates finite element analysis on magnet height, orientation, and grooves for drag force reduction.

FIG. 43B illustrates how these parameters improve the lift-to-drag ratio at varying speeds (360 km/h and 650 km/h).

FIG. 43C illustrates performance comparisons showing the technology's lift-to-drag ratio advantage over other systems.

### DETAILED DESCRIPTION

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein.

The levitation and guidance systems described here are based on a homopolar magnetic field configuration, where the magnetic field is oriented transversely to the direction of motion. This design helps minimize drag losses and allows the use of solid iron for the track, thereby reducing costs, as solid iron is more affordable and easier to manufacture and install compared to laminated iron.

The use of an air-core LSM for propulsion simplifies the LSM architecture and reduces costs on the track side by utilizing only coils, eliminating the need for laminated iron, which is significantly more expensive and complex to install.

Additionally, the integration of permanent magnets in the hybrid active-passive levitation system significantly reduces Joule losses in the control coils, as only a low current is required to regulate the air gap. The capsule's weight is fully supported by the force generated by the permanent magnets, further enhancing system efficiency.

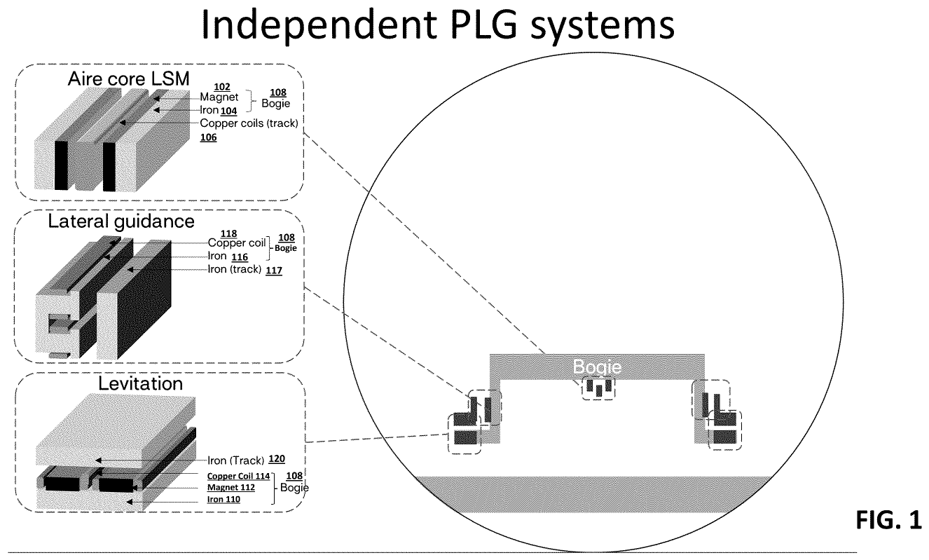

FIG. 1 provides an overview of the PLG (Propulsion, Levitation, and Guidance) systems integrated into the bogie of a capsule-based transportation system. The figure highlights the active components of each system:
Hybrid Active-Passive Levitation System: This system includes an iron core, permanent magnets, and control coils on the bogie side, while the track side consists of an iron track.
Active Guidance System: Comprising control coils and an iron core on the bogie side, with iron elements on the track side.
Air-Core Linear Synchronous Motor (LSM) System: Features coils on the track and a combination of permanent magnets and iron on the bogie.

### Materials for Levitation and Guidance Systems

The track-side electrical coils can be made from copper or aluminum.
The permanent magnets can be high-performance grades such as Neodymium-Iron-Boron (NdFeB) or Samarium-Cobalt (SmCo).
The iron core can be either laminated or solid.
Alternatively, the air-core Linear Synchronous Motor system can be designed without back iron on the bogie-side, utilizing only a Halbach array of permanent magnets to reduce the bogie mass.

The active components of the air-core Linear Synchronous Motor (LSM) located on the bogie side comprise permanent magnets and back iron. The magnetic assembly consists of multipolar permanent magnets affixed to a back iron structure. These assemblies are arranged in two opposing sections, positioned face-to-face, enabling the magnetic field to traverse the air gap between them. The polarity of the permanent magnets in each opposing section is aligned in the same direction to ensure proper magnetic flux orientation. The magnetic field completes its circuit through the back iron, facilitating efficient flux return. These two opposing assemblies constitute the secondary part of the LSM and are securely mounted on the bogie.

One approach to simplify the design is to utilize a single magnetic assembly section instead of two. This can be achieved by retaining just one permanent magnet and its corresponding iron section assembly while eliminating the other. The remaining assembly is then rotated 90 degrees so that the permanent magnet is oriented downward, toward the base of the vehicle. This modification is also applied to the electrical coils, resulting in a flat or horizontal single secondary air-core LSM instead of a vertical double secondary air-core LSM.

Alternatively, the system can be designed without a back iron for both the flat and vertical configurations of the LSM, utilizing only a Halbach array of permanent magnets. This design choice reduces the overall mass of the bogie while maintaining effective magnetic performance. In this configuration, the traditional magnetic assembly of multipolar permanent magnets fixed to the back iron support can be replaced with a Halbach array of permanent magnets, which enhances the multipolar magnetic field on the side where the coils are located while canceling it on the other.

The material used for the permanent magnets can include high-performance grades such as Neodymium-Iron-Boron (NdFeB) or Samarium-Cobalt (SmCo), among others, depending on the desired magnetic characteristics. The material for the back iron can be any solid or laminated electrical steel similar to that used in rotary electrical machines, ensuring optimal magnetic properties and performance.

The active components of the lateral guidance system on the bogie side consist of an electromagnet composed of coils and an iron core. The electromagnet is constructed using a U-shaped iron core that supports two coils, each wound around one of the two arms of the U-shaped structure. The material for the iron core can be any solid or laminated electrical steel or a combination of both, similar to that used in rotary electrical machines, ensuring optimal magnetic properties and performance. The material of the electrical coils can be any good electrical conductor, such as copper or aluminum. Copper is often preferred due to its high electrical conductivity, which contributes to efficient energy transmission and overall system performance. Aluminum, while slightly less conductive than copper, offers advantages such as reduced weight and lower cost, making it a viable alternative in applications where weight savings are critical. The choice of material for the coils will depend on the specific requirements of the system, including factors such as conductivity, weight, cost, and thermal management.

Multiple electromagnets are evenly distributed along both sides of the bogie, ensuring the vehicle's lateral guidance and stability. The total number of electromagnet modules is selected based on the mass of the vehicle, as this directly relates to the centrifugal force that must be countered during a curve. By adjusting the number of modules, it becomes straightforward to achieve an effective lateral guidance system tailored to the specific requirements of the vehicle. This flexibility allows for optimized performance under various operating conditions.

The entire guidance module assembly is embedded in epoxy resin. This provides a robust and stable support structure, ensuring that all elements remain firmly in position during operation.

The active components of the hybrid active-passive levitation system include permanent magnets, coils, and an iron core. The magnetic assembly consists of homopolar permanent magnets affixed to an iron core, meaning that two parallel rows of permanent magnets are aligned along the direction of vehicle movement. In this homopolar configuration, all magnets within the same row maintain the same polarity, while the two opposing rows have opposite polarities. As a result, the magnetic field flows from one row to the other, passing through the air gap, the iron track, and the iron core.

The iron core can have a simple rectangular shape, as illustrated in FIG. 1, or a U-shaped design to better accommodate the coils. The simplest way to integrate the coils with the permanent magnets and iron core is to position them in the space between the two magnet rows, resulting in two coils—one surrounding each row of permanent magnets.

An alternative and more practical approach involves using a U-shaped iron core similar to that of the lateral guidance electromagnet. In this configuration, the coils are housed in the same manner as in the lateral guidance system.

The entire levitation module assembly is embedded in epoxy resin. This provides a robust and stable support structure, ensuring that all elements remain firmly in position during operation.

The material used for the permanent magnets can include high-performance grades such as Neodymium-Iron-Boron (NdFeB) or Samarium-Cobalt (SmCo), among others, depending on the desired magnetic characteristics. The material for the iron core can be any solid or laminated electrical steel or a combination of both, similar to that used in rotary electrical machines, ensuring optimal magnetic properties and performance. The material of the electrical coils can be any good electrical conductor, such as copper or aluminum. Copper is often preferred due to its high electrical conductivity, which contributes to efficient energy transmission and overall system performance. Aluminum, while slightly less conductive than copper, offers advantages such as reduced weight and lower cost, making it a viable alternative in applications where weight savings are critical. The choice of material for the coils will depend on the specific requirements of the system, including factors such as conductivity, weight, cost, and thermal management.

The levitation modules are evenly distributed along both sides of the vehicle capsule, ensuring stable levitation throughout its movement. The total number of levitation modules is selected based on the mass of the vehicle, as this directly relates to the weight force that must be countered. By adjusting the number of modules, it becomes straightforward to achieve an effective levitation system tailored to the specific requirements of the vehicle. This flexibility allows for optimized performance under various operating conditions.

The active components of the air-core Linear Synchronous Motor (LSM) located on the track side are the coils, which constitute the stator or primary of the LSM. The primary consists of coils that are positioned between the two opposing multipolar permanent magnet assemblies mounted on the bogie. This primary structure is securely attached to the track. The coils are configured as a three-phase winding, similar to the winding used in rotary electrical machines. The simplest way to implement the three-phase winding is through a single-turn three-phase winding. In this configuration, the coil for each phase consists of just one turn rather than multiple turns. This approach allows for the use of standard electrical wire to constitute the winding, simplifying the manufacturing process and reducing the overall complexity of the system. The LSM is referred to as an air-core system because no iron is used to support the coils, eliminating iron-induced losses and enhancing performance.

The three phases' coils assembly is embedded in epoxy resin. This provides a robust and stable support structure, ensuring that all elements remain firmly in position during operation.

The material of the electrical coils can be any good electrical conductor, such as copper or aluminum. Copper is often preferred due to its high electrical conductivity, which contributes to efficient energy transmission and overall system performance. Aluminum, while slightly less conductive than copper, offers advantages such as reduced weight and lower cost, making it a viable alternative in applications where weight savings are critical. The choice of material for the coils will depend on the specific requirements of the system, including factors such as conductivity, weight, cost, and thermal management.

The active component of the lateral guidance system located on the track is the iron track. The iron track beam is a fundamental component of the lateral guidance system, serving as the counterpart to the electromagnets mounted on the bogie. It is a continuous iron structure securely attached to the track, designed to interact with the bogie-side electromagnets through magnetic attraction. This interaction generates the necessary guiding force to maintain the vehicle's lateral stability. The material of the track beam is solid iron, which helps reduce costs and simplifies manufacturing and installation processes.

The primary difference lies in its orientation, as the levitation system's iron track is positioned in the horizontal plane.

To simplify the overall iron track structure, the iron tracks dedicated to each system (levitation and guidance) on each side of the vehicle can be assembled together to form an L-shaped iron track. This integrated design enhances structural efficiency while maintaining the functionality of both systems.

The interaction between the active components of the hybrid active-passive levitation system is fundamentally based on magnetic. The two parallel rows of homopolar permanent magnets generate a magnetic field that flows from one row to the other. This field traverses the air gap between the magnet rows, interacts with the iron track creating a strong magnetic attraction, and completes its circuit through the iron core.

The weight of the vehicle is primarily supported by the levitation force generated by the permanent magnets. The coils, positioned near the iron core, are used solely for control purposes. When current flows through the coils, they generate a magnetic field that interacts with the magnetic fields produced by the permanent magnets. This interaction allows for dynamic adjustments to the levitation height and overall stability of the vehicle.

As the vehicle moves, the interplay between the magnetic fields of the permanent magnets and the coils enables precise control of the levitation force. By varying the current supplied to the coils, the system can modulate the magnetic attraction, maintaining stability and responsiveness to changing conditions, such as variations in load or track irregularities.

The air gap between the permanent magnets and the iron track is continuously monitored by air gap sensors, which provide real-time feedback to the control system. By dynamically adjusting the current supplied to the coils, the system maintains a stable and optimal air gap, compensating for external disturbances such as track irregularities or load variation.

The interaction between the active components of the air-core Linear Synchronous Motor (LSM) on the bogie side and the track side is based on the principles of magnetic field dynamics.

The coils positioned in the air gap between the opposing permanent magnet assemblies. When a three-phase current is supplied to the coils, a traveling magnetic field is generated along the length of the track, oriented in the direction of the vehicle's motion. This traveling magnetic field interacts directly with the stationary permanent magnets located on the bogie.

The interaction between the traveling magnetic field and the permanent magnets produces a propulsive force, effectively driving the vehicle forward. This mechanism facilitates contactless propulsion, which is particularly advantageous for applications such as maglev trains, as it minimizes friction and allows for high-speed travel. Additionally, by adjusting the frequency of the supplied three-phase current, precise control over the speed and acceleration of the vehicle can be achieved, enhancing operational efficiency and performance.

Overall, the coordinated interaction between the stationary components on the track side and the movable components on the bogie side creates a robust and efficient propulsion system that leverages the benefits of magnetic levitation and synchronous motor technology.

The interaction between the active components of the lateral guidance system on the bogie side and the iron track on the infrastructure side is based on electromagnetic attraction. The U-shaped electromagnets on the bogie generate a controllable magnetic field by regulating the current in their coils. This magnetic field induces an attractive force between the electromagnets and the iron track, ensuring the vehicle remains aligned within its designated path.

The air gap between the electromagnets and the iron track is continuously monitored by air gap sensors, which provide real-time feedback to the control system. By dynamically adjusting the current supplied to the electromagnet coils, the system maintains a stable and optimal air gap, compensating for external disturbances such as track irregularities or lateral forces acting on the vehicle.

The iron track serves as a passive counterpart, providing a stable ferromagnetic surface for interaction with the electromagnets.

By evenly distributing multiple electromagnets along both sides of the bogie, the system achieves smooth and continuous lateral guidance, contributing to the vehicle's overall stability and precise trajectory control.

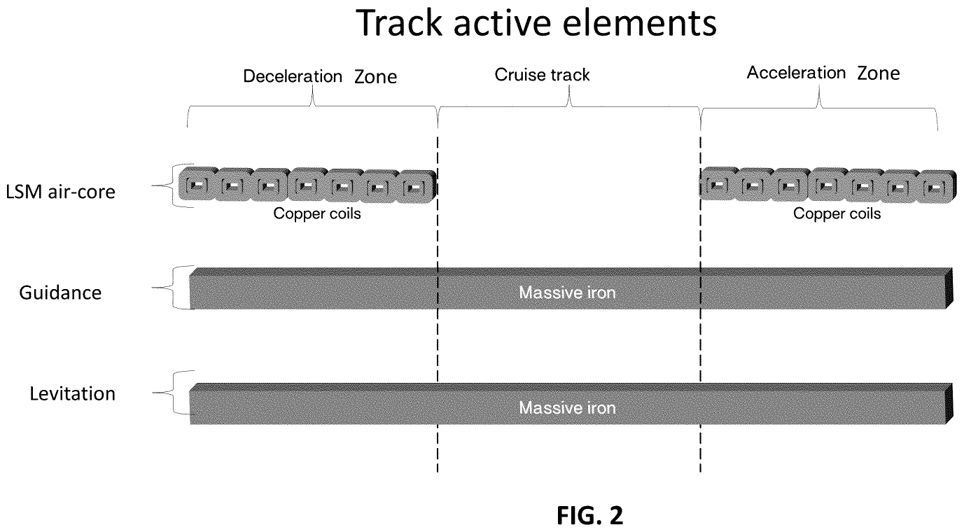

FIG. 2 illustrates the composition of a typical track in terms of active materials. Assuming a track extending from point A (right side of the figure) to point B (left side of the figure), the entire track consists of solid (massive) iron to support the levitation and guidance systems. However, the electrical coils of the LSM are only required in specific sections of the track:
Acceleration zone, where the capsule requires propulsion force to reach its maximum velocity.
Deceleration zone, where braking forces are applied to bring the capsule to a stop.

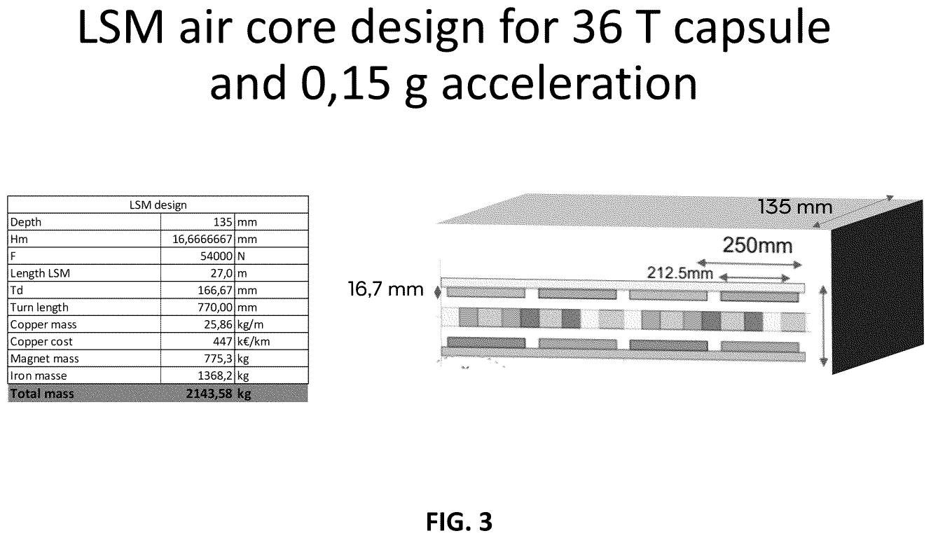

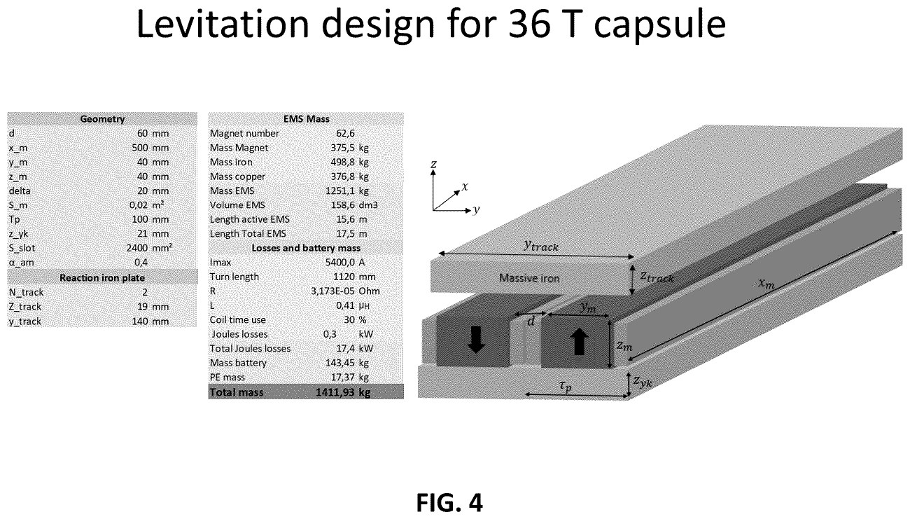

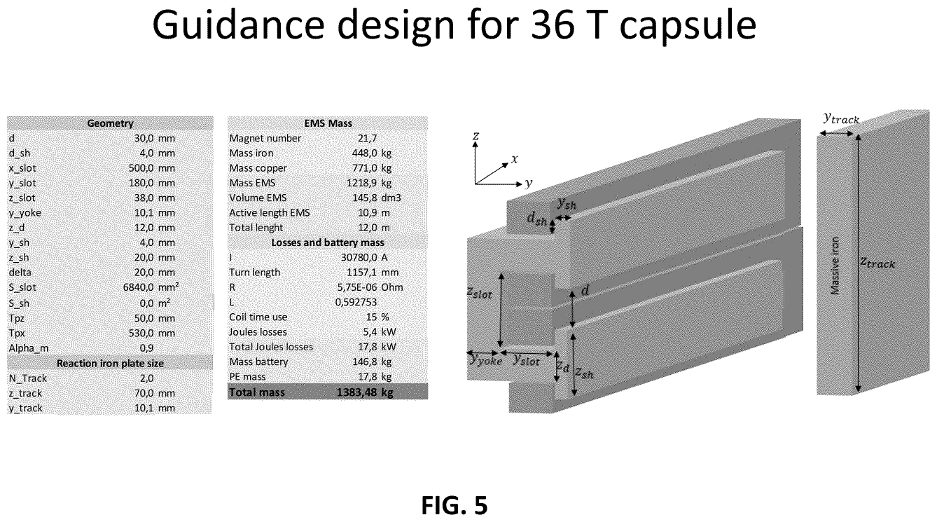

FIGS. 3, 4, and 5 present an example of a preliminary design of the PLG systems for a capsule-based transportation system with a mass of 36 tons. The figures highlight the main geometrical parameters, electromechanical characteristics, as well as the masses and costs of the active materials for each system.

In one embodiment, the present invention provides a bogie side propulsion, guidance, and levitation system comprising: (a) an air core linear synchronous motor comprising: (i) a first back iron (104) with a first set of multipolar permanent magnets (102) affixed to a backside of the first back iron (104); (ii) a second back iron (104) with a second set of multipolar permanent magnets (102) affixed to a backside of the second back iron (Iron 104); wherein the first back iron (104) and the second back iron (104) are attached to an underside of a bogie (108) with the first set of multipolar magnets (102) opposing the second set of multipolar magnets (102) with an air gap formed in between them, and wherein polarity of permanent magnets (102) in each opposing section of the first back iron (104) and the second back iron (104) is aligned in a similar direction to ensure proper magnetic flux orientation; (b) a lateral guidance system comprising a plurality of electromagnets, each of the plurality of electromagnets comprising a U-shaped metal core (116) with each post in the U-shaped metal core (116) having a coil (118) wound thereon; (c) a hybrid active-passive levitation system (Iron 110, Magnet 112, Copper Coil 114) comprising: (i) a plurality of homopolar permanent magnets (112); (ii) an iron core (110), wherein two parallel rows of homopolar permanent magnets (112) are aligned along a direction of capsule movement, with all homopolar magnets within the same row maintaining a similar polarity, while two opposing rows have opposite polarities, with a magnetic field flowing from one row to the other, passing through the air gap, an iron track (iron 120), and the iron core (110).

In one embodiment, the bogie side propulsion, guidance and levitation system is implemented in a partial vacuum tunnel.

In one embodiment, either the first set of multipolar permanent magnets or the second set of multipolar permanent magnets, or a combination thereof, comprises Neodymium-Iron-Boron (NdFeB) magnets.

In one embodiment, either the first set of multipolar permanent magnets or the second set of multipolar permanent magnets, or a combination thereof, comprises Samarium-Cobalt (SmCo) magnets.

In one embodiment, the U-shaped metal core is a iron core.

In one embodiment, the coil wound on the U-shaped iron core is made from copper.

In one embodiment, the coil wound on the U-shaped iron core is made from Aluminum.

In one embodiment, a total number of the plurality of electromagnets is picked based on the mass of the capsule.

In one embodiment, the hybrid active-passive levitation system is embedded in epoxy resin.

In another embodiment, the present invention provides a track side propulsion, guidance, and levitation system comprising: (a) an air core linear synchronous motor stator comprising: (i) a plurality of three-phase coils (106), and (ii) an epoxy resin structure embedding the three-phase coils (106), wherein the three-phase coils (106) are configured to generate a traveling electromagnetic field that interacts with a bogie-mounted set of multipolar permanent magnets (102) to propel the vehicle; (b) a lateral guidance track portion comprising a first ferromagnetic track (117), wherein the first ferromagnetic track (117) is configured to interact with a bogie-mounted plurality of electromagnets (U-shaped iron core 116, copper coil 118) to provide lateral guidance; and (c) a levitation track portion comprising a second ferromagnetic beam (120) arranged substantially horizontally, wherein the second ferromagnetic beam (120) is configured to interact with a bogie-mounted hybrid active-passive levitation system (Iron 110, Magnet 112, Copper Coil 114) to provide lift.

In one embodiment, the track side propulsion, guidance, and levitation system is implemented in a partial vacuum tunnel.

In one embodiment, the three-phase coils of the air core linear synchronous motor stator are arranged in a single-turn configuration to simplify manufacturing and reduce overall system cost.

In one embodiment, each of the plurality of three-phase coils of the air core linear synchronous motor stator is made from copper.

In one embodiment, each of the plurality of three-phase coils of the air core linear synchronous motor stator is made from aluminum.

In one embodiment, the lateral guidance track portion and the levitation track portion are integrated together to form an L-shaped cross section, simplifying the structural design.

In one embodiment, the first ferromagnetic track in the lateral guidance track portion and the second ferromagnetic track in the levitation track portion both comprise solid iron.

In one embodiment, the plurality of three-phase coils in the air core linear synchronous motor stator is distributed along a track in segments, each segment energizable independently based on a position of the capsule to optimize energy usage.

In one embodiment, the epoxy resin structure provides mechanical support and environmental protection to the plurality of three-phase coils, preserving precise coil positioning and mitigating vibrational effects during high-speed operation.

In yet another embodiment, the present invention provides a method of levitating, propelling, and guiding a capsule traveling along a track in at least a partial vacuum tunnel, the method comprising: (a) generating a propulsive force by supplying a three-phase current to a plurality of three-phase coils (106) embedded in an epoxy resin structure on the track side, thereby creating a traveling electromagnetic field in an air core linear synchronous motor stator; (b) interacting the magnetic fields of the traveling electromagnetic field with at least a first set of multipolar permanent magnets (102) and a second set of multipolar permanent magnets (102) affixed to respective back irons (104) on an underside of a bogie (108), wherein each set of multipolar permanent magnets (102) opposes the other across an air gap, causing a propulsive force on the bogie (108); (c) providing lateral guidance by energizing a plurality of electromagnets on the bogie side, each of the plurality of electromagnets comprising a U-shaped metal core (116) with a coil (118) wound on each post, to induce electromagnetic attraction with a first ferromagnetic track portion (117) arranged substantially vertically, thereby controlling lateral positioning of the capsule; (d) establishing hybrid active-passive levitation by arranging two parallel rows of homopolar permanent magnets (112) of similar polarity within each row and opposite polarities between rows, wherein each row is affixed to an iron core (110) on the bogie (108), and interacting said rows with a second ferromagnetic track portion (120) arranged substantially horizontally, such that the weight of the capsule is supported by magnetic forces and selectively modulated by energizing one or more coils (114) adjacent to the homopolar permanent magnets (112); and (e) maintaining air gaps between the bogie-mounted permanent magnets (102, 112) or electromagnets (116, 118) and the respective ferromagnetic track portions (117, 120), wherein sensors monitor the air gaps, and a control system adjusts current in the three-phase coils (106) or the electromagnet coils (118, 114) to ensure stable propulsion, guidance, and levitation throughout capsule travel.

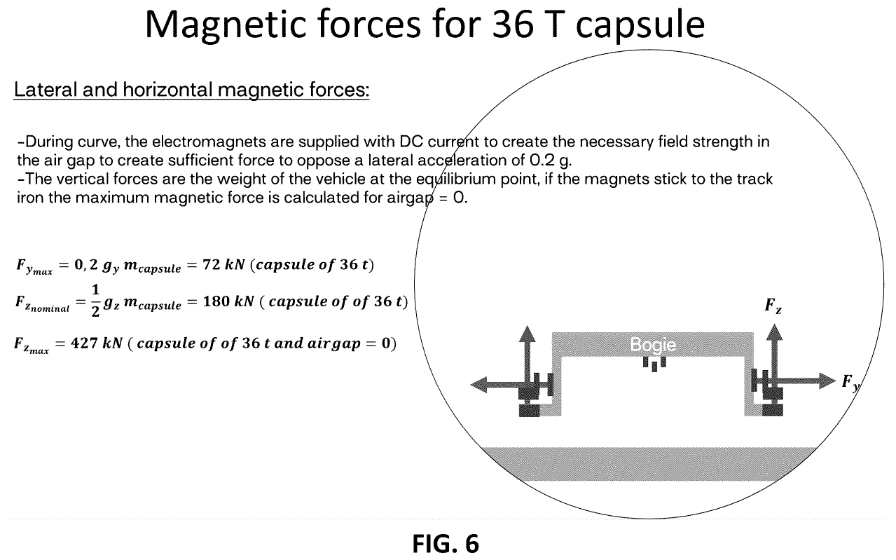

FIG. 6 presents a calculation of the forces acting on the capsule's bogie in both the lateral and vertical directions, generated by the guidance and levitation systems. The worst-case scenario for the guidance system occurs during a curve, where the capsule experiences a lateral acceleration of 0.2 g due to the centrifugal force. The worst-case scenario for the levitation system corresponds to the situation where the permanent magnet adheres to the iron track.

### Levitation Airgap Control Strategy

The control strategy described in this section minimizes Joule losses in the coils by enabling zero steady-state current control. This approach ensures that the minimum possible current—and consequently the lowest energy losses—is achieved, even when the capsule's mass varies due to changes in the number of passengers or luggage weight.

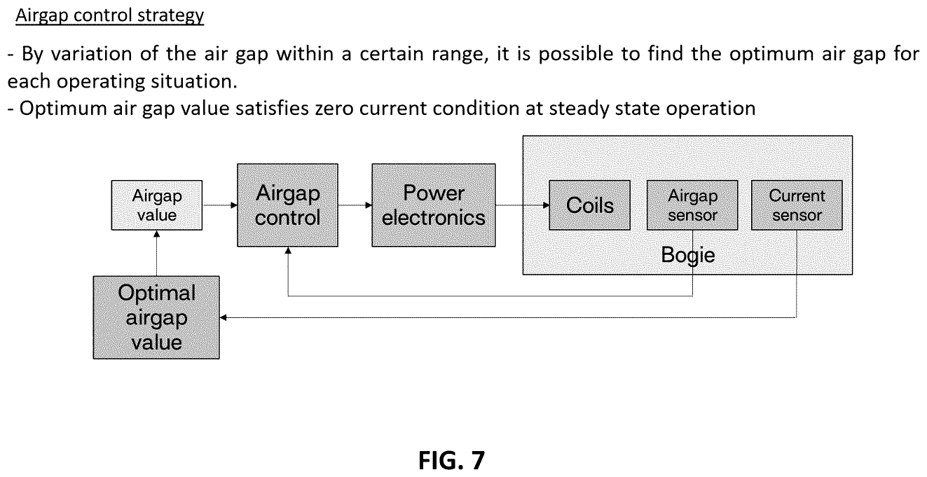

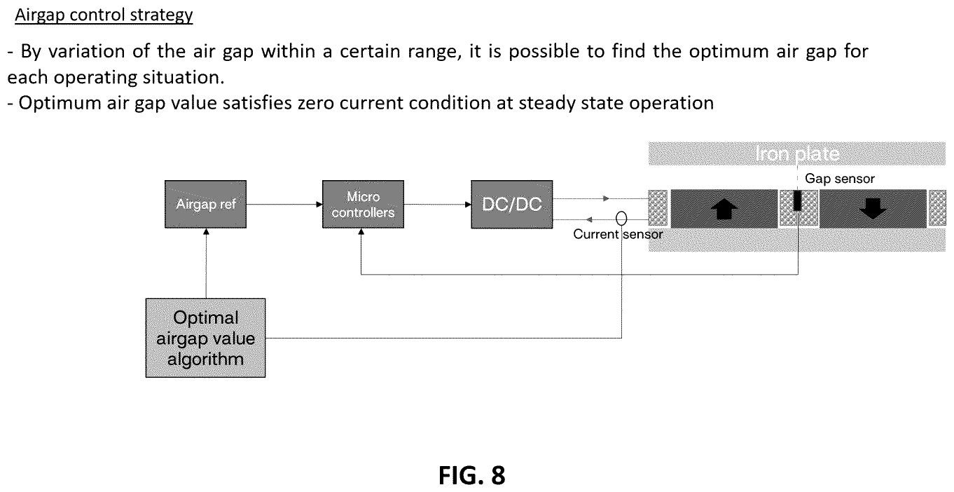

FIGS. 7 and 8 illustrate a schematic of an optimal control strategy for regulating the levitation gap. Due to variations in the total mass of the capsule on each trip—primarily caused by changes in the number of passengers and luggage weight—maintaining a constant air gap would result in zero control current for the levitation magnet only at a specific capsule mass.

If the capsule mass increases, the control system must inject a positive current to strengthen the magnetic flux and increase the levitation force. Conversely, if the capsule mass decreases, a negative current is applied to weaken the flux and reduce the levitation force. By implementing an adaptive air-gap control strategy, it becomes possible to maintain zero current in the control coils by adjusting the air gap value. If the total mass of the capsule increases, the air gap is reduced to generate greater levitation force, whereas if the mass decreases, the air gap is increased to reduce the force.

As shown in FIGS. 7 and 8, the algorithm selects a reference air gap value for the system. The air-gap control system then regulates a DC/DC converter to generate the required current in the electrical coils, producing the necessary levitation force to achieve the desired gap.

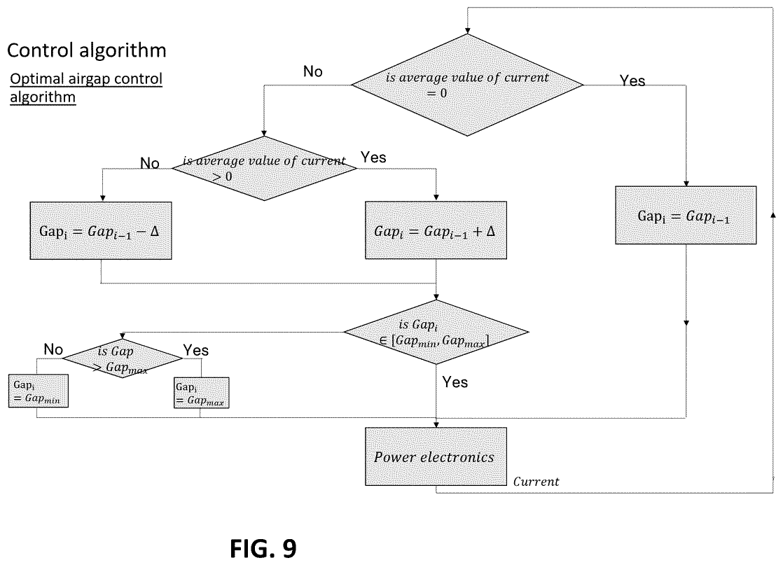

FIG. 9 illustrates how the algorithm functions. At each moment, it checks the average value of the control current:
If the current is zero, the air gap remains unchanged.
If the current is positive, the air gap is increased.
If the current is negative, the air gap is decreased.

The final step of the algorithm ensures that the new air gap remains within a safe range. Large variations must be avoided to prevent the capsule from falling or the magnets from adhering to the iron track. If the calculated air gap is within the safe range, it is applied to the system. Otherwise, a final check determines whether the gap exceeds the safe limits:
If it is greater than the maximum allowed value, the maximum limit is used as the reference.
If it is smaller than the minimum allowed value, the minimum limit is set as the reference.

### Switching Concept

This section describes an efficient and straightforward switching concept that relies solely on the PLG systems of the bogie. There is no need for any mechanical moving parts on the track to achieve switching. The concept is based on the duplication of the previously described levitation and guidance systems.

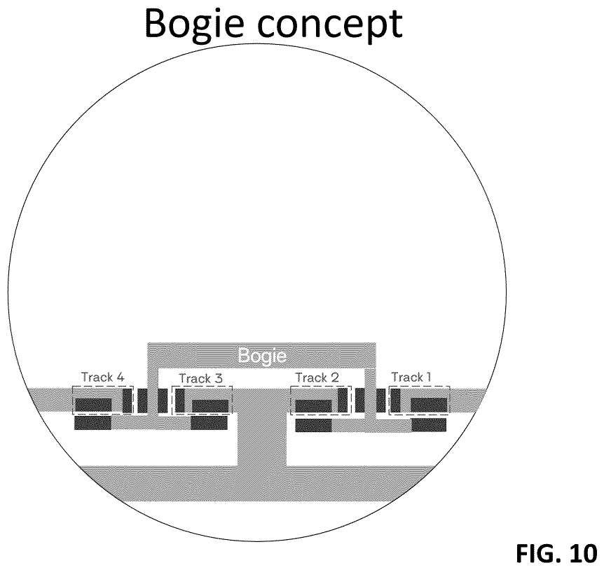

FIG. 10 presents a modified bogie concept designed to enable switching between two tracks. This concept is based on the bogie shown in FIG. 1, with the levitation and guidance systems remaining unchanged. The key modification lies in the duplication of tracks and their corresponding levitation and guidance systems. As a result, there are four tracks dedicated to levitation and four tracks dedicated to guidance, with each track having its own dedicated levitation or guidance system.

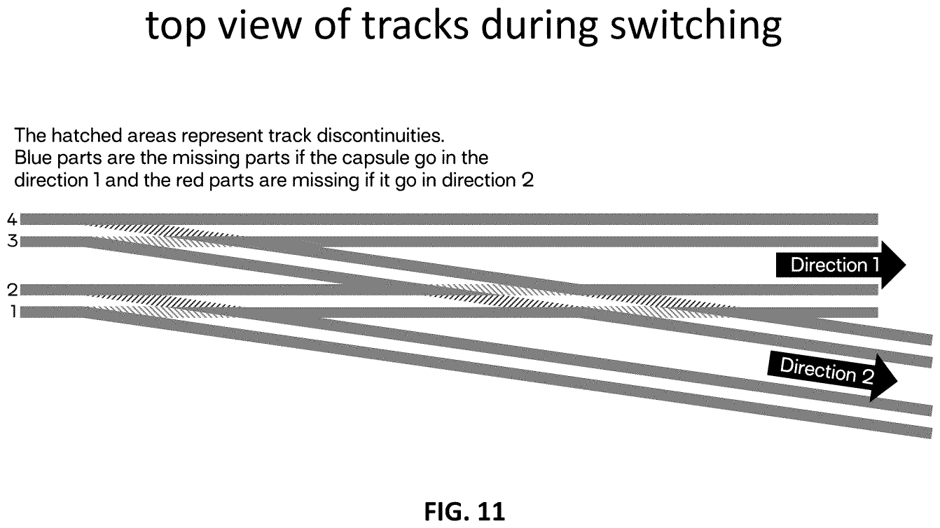

FIG. 11 provides a top view of the levitation track during a typical switching maneuver. The capsule is assumed to approach from the left and must choose between two possible directions. The solid bands represent sections of the iron track available for levitation, while the hatched areas indicate sections of the iron track that have been removed to allow the capsule's bogie to pass through.

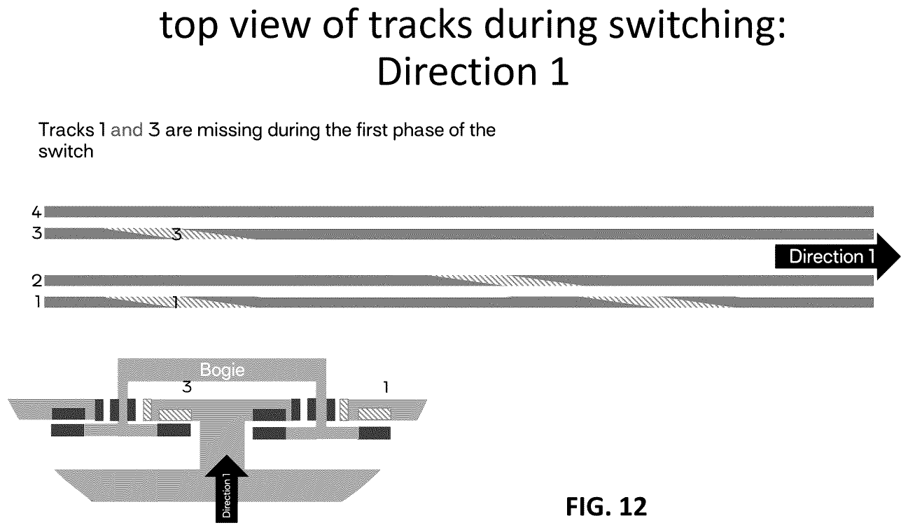

FIGS. 12, 13, and 14 simplify the representation of FIG. 11 by illustrating the configuration of the iron track when the capsule takes direction 1.

In FIG. 12, as the capsule approaches the section of the track where iron tracks 1 and 3 are absent, it cannot rely on levitation systems 1 and 3. Instead, it remains supported by levitation systems 2 and 4.

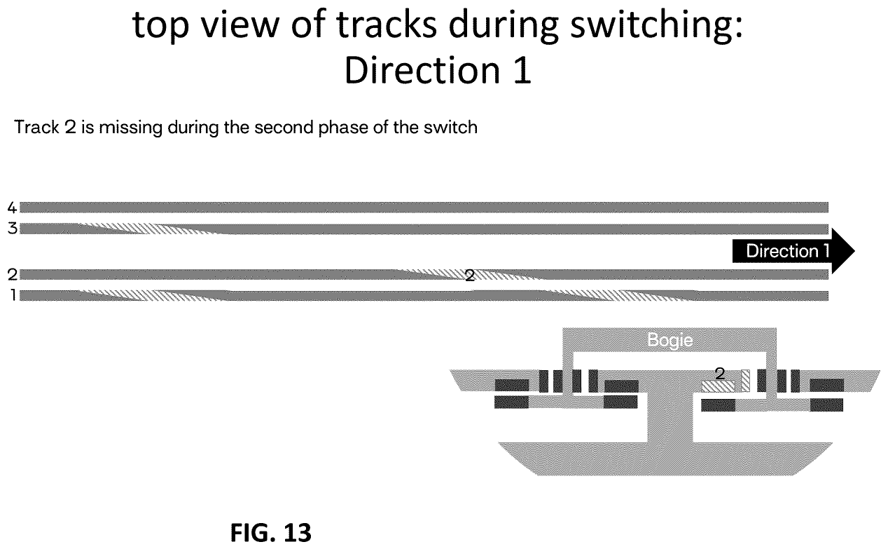

In FIG. 13, the capsule reaches a section where iron track 2 is missing. At this point, it continues levitating using systems 1, 3, and 4.

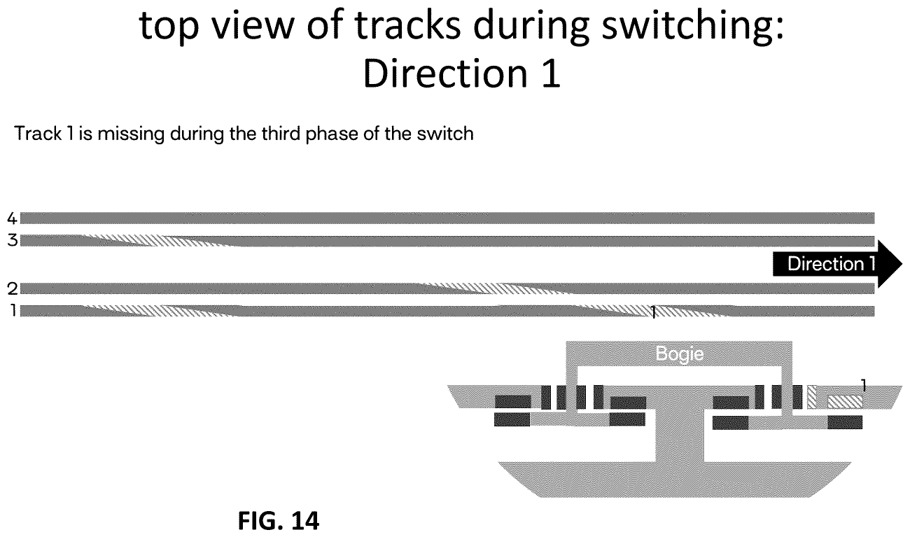

Similarly, in FIG. 14, iron track 1 is absent, and the capsule maintains levitation by relying on tracks 2, 3, and 4.

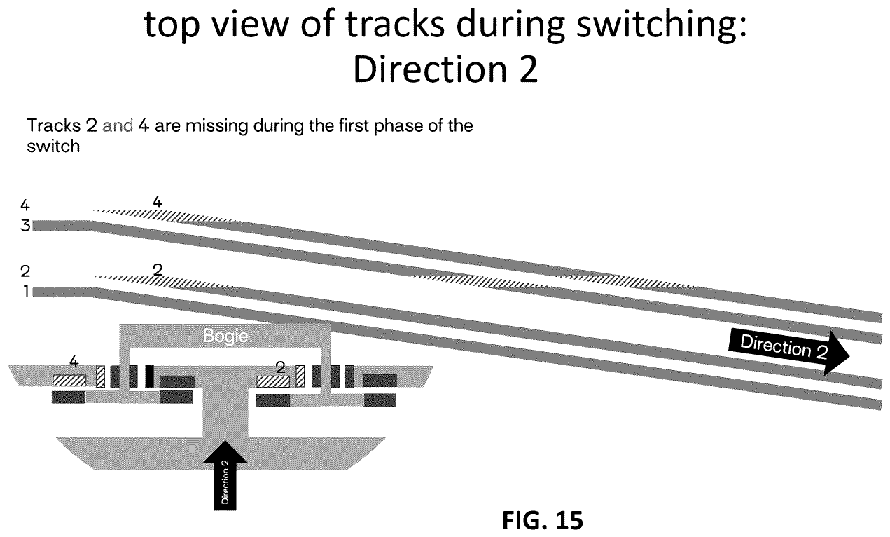

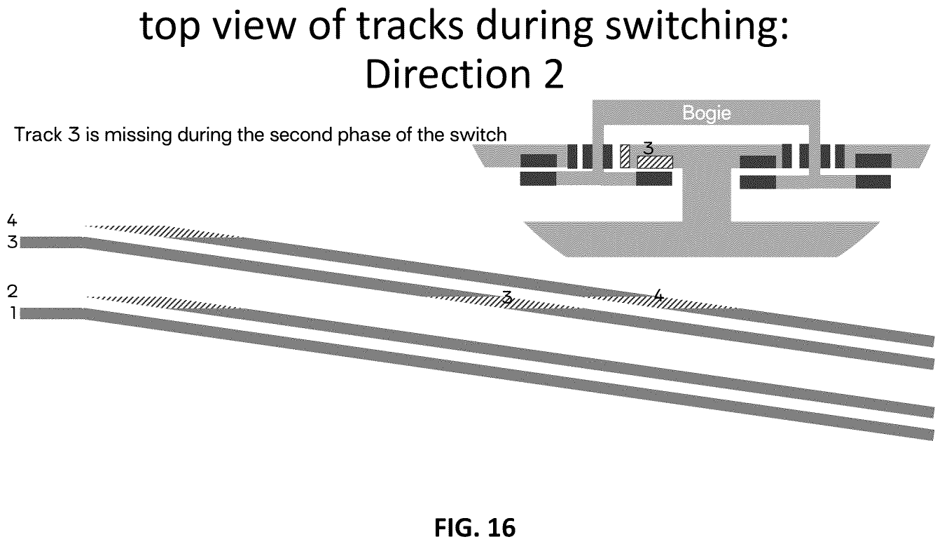

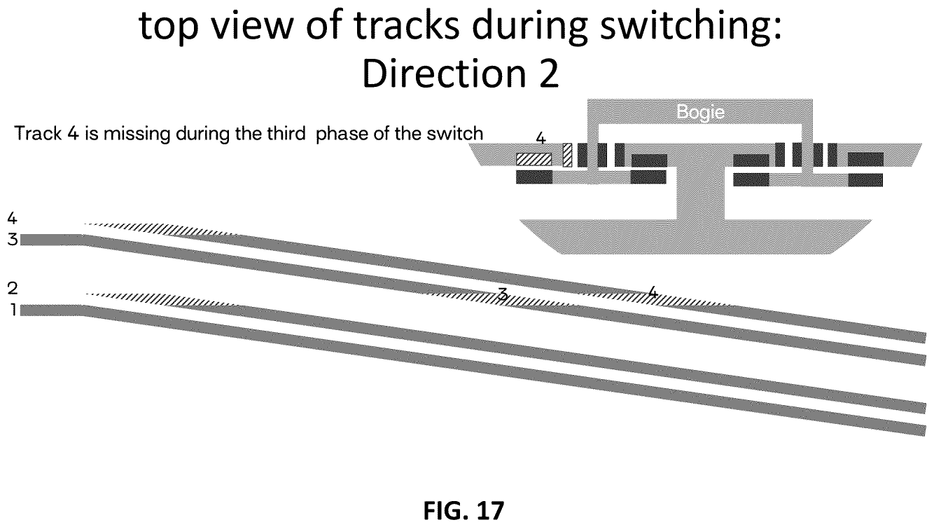

FIGS. 15, 16, and 17 simplify the representation of FIG. 11 by illustrating the configuration of the iron track when the capsule takes direction 2. As we can observe, whether the capsule takes direction 2 or direction 1, it will always be supported by at least two levitation systems throughout the switching process, with at least one system on each side.

### Issues Encountered and Potential Solutions

Now, let's examine the lateral guidance system in the same manner as the levitation system. A similar analysis can be conducted regarding the available track portions during each phase of the switching process. However, we must be cautious about the behavior of the guidance system.

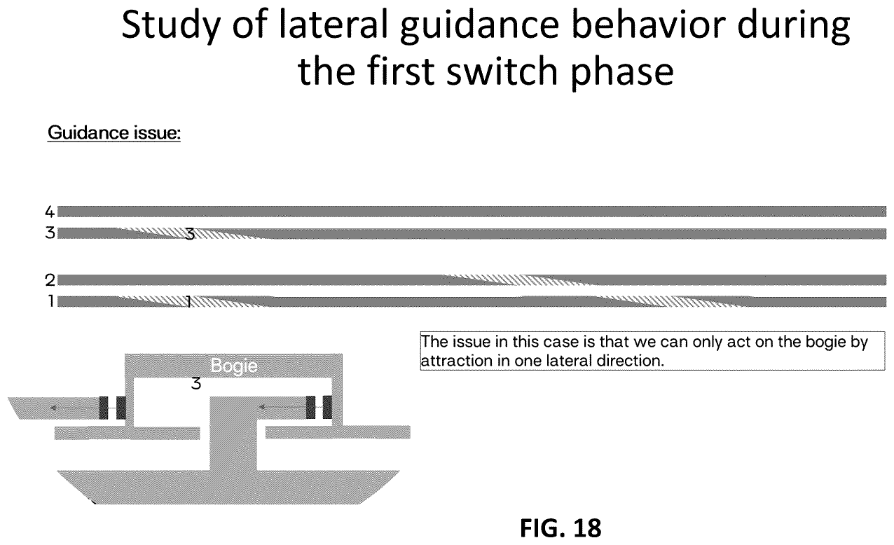

To illustrate a potential issue related to the guidance system during the switching process and its possible solutions, we will refer to the scenario depicted in FIG. 18, which shows the capsule approaching from the left and taking direction 1 during the switch.

As the guidance system operates solely through attractive forces, the challenge in this case is that we can only act on the bogie by attraction in one lateral direction. This means that if the capsule approaches the track in the direction indicated by the arrows in FIG. 18, there is no way to push the capsule away.

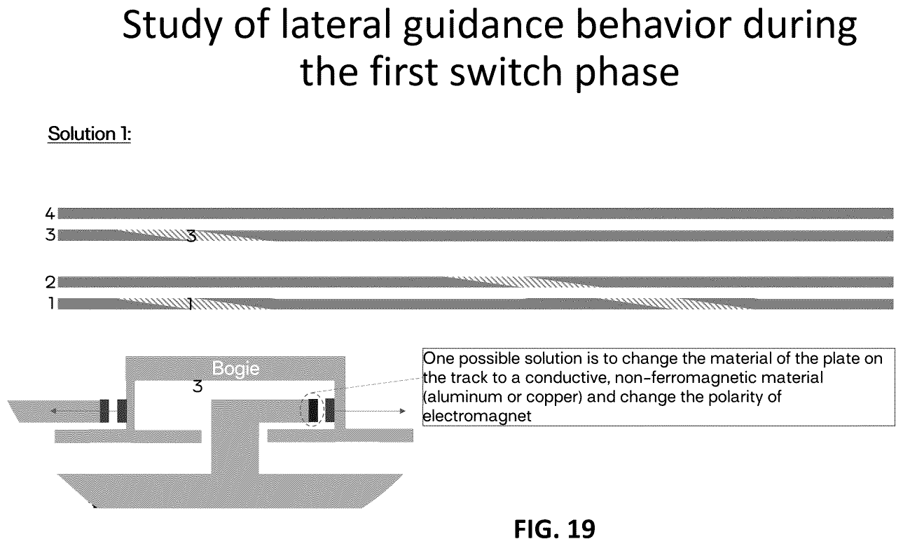

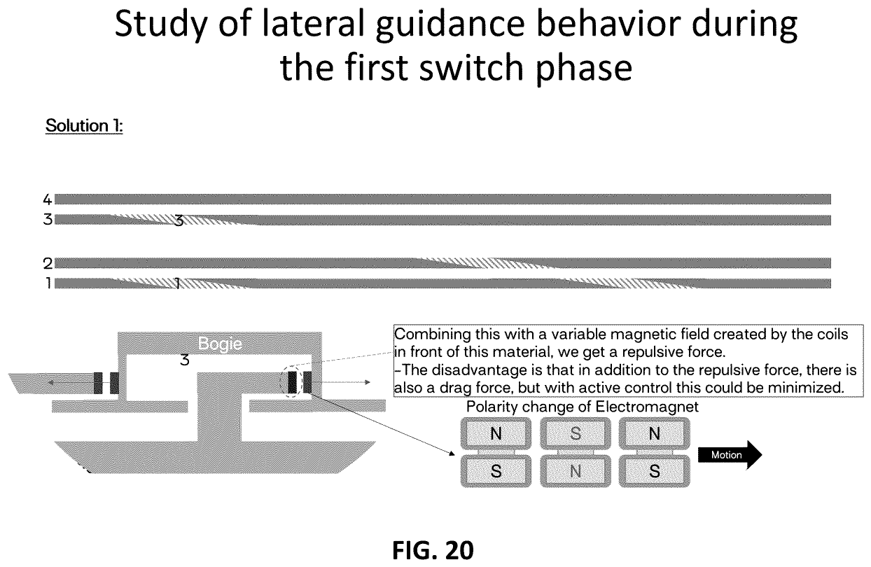

FIG. 19 presents a potential solution to this problem, which involves replacing the material of iron track number 2 with a conductive, non-ferromagnetic material (such as aluminum or copper) and changing the polarity of the electromagnet. This adjustment allows for the creation of a repulsive force if the capsule gets too close to the track. The polarity of the guidance coils is reversed, as shown in FIG. 20. The blue arrow indicates the direction of the repulsive force, while the red arrow shows the attractive force. In this way, the capsule is stabilized in both directions.

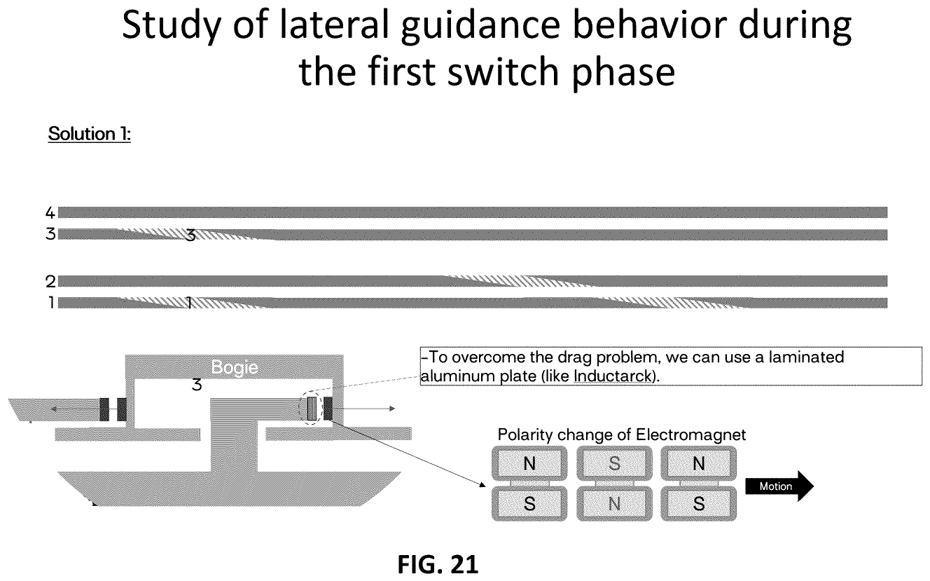

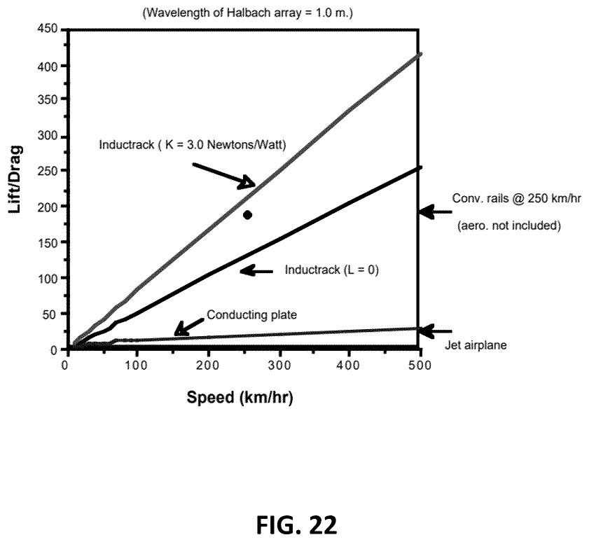

However, the disadvantage of this approach is that, in addition to the repulsive force, there is also a drag force. FIG. 21 illustrates a solution to mitigate the drag problem by using a laminated aluminum plate (like Inductrack). FIG. 22 demonstrates the reduction in drag force achieved using Inductrack technology (red curve) compared to a conventional conductive plate (blue curve).

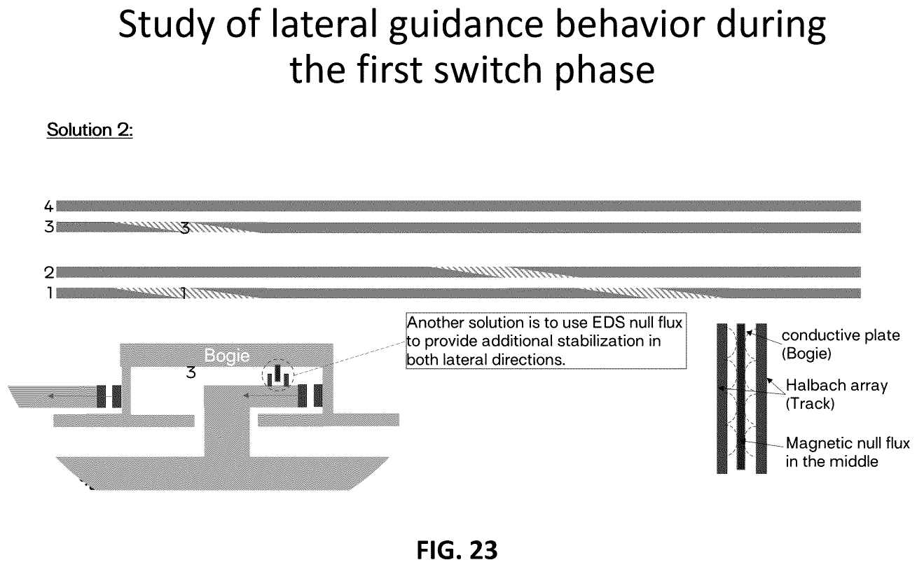

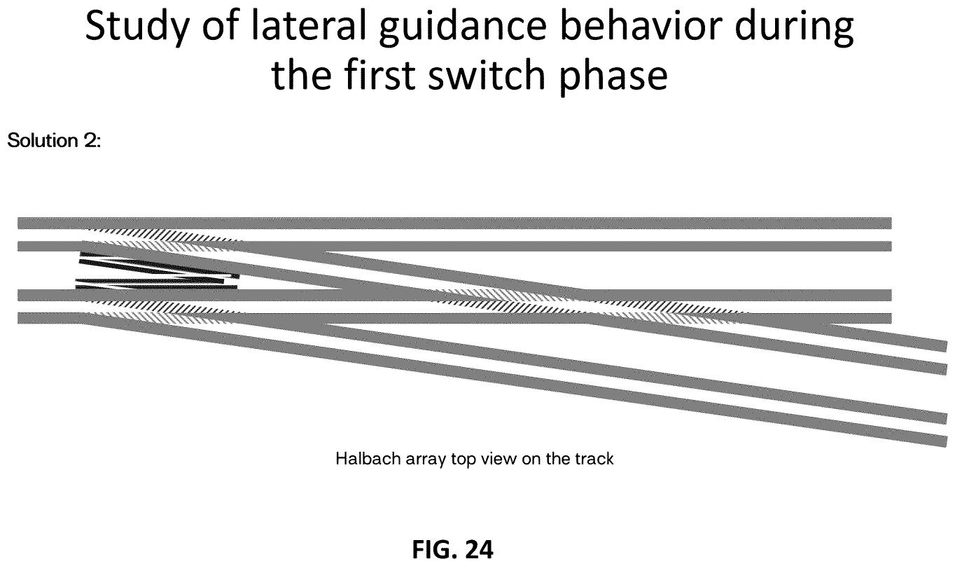

Another solution involves utilizing an Electrodynamic Suspension (EDS) null flux system to provide additional stabilization in both lateral directions as shown in FIG. 23. In this case, a conductive plate is placed on the bogie (blue rectangle) and, during the switching process, it passes between two Halbach arrays. If the bogie deviates from the centerline, a stabilizing force is naturally generated to center the capsule. FIG. 24 shows the placement of the Halbach arrays on the track.

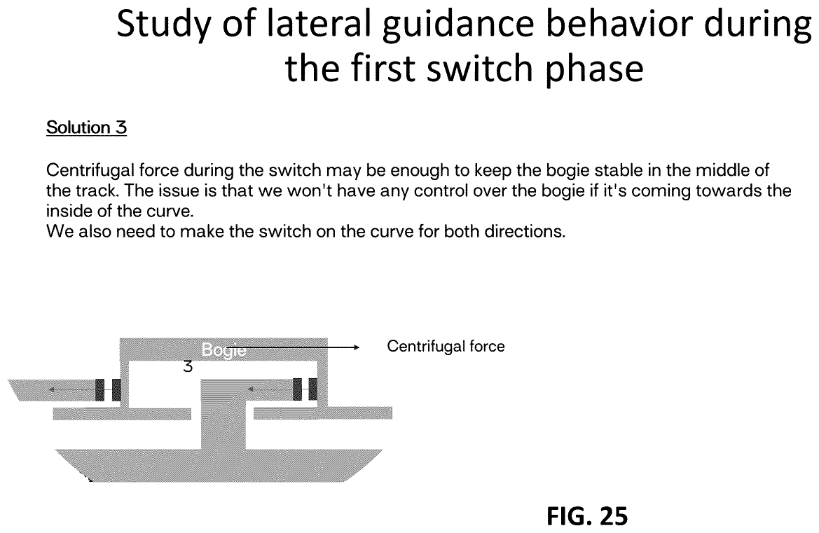

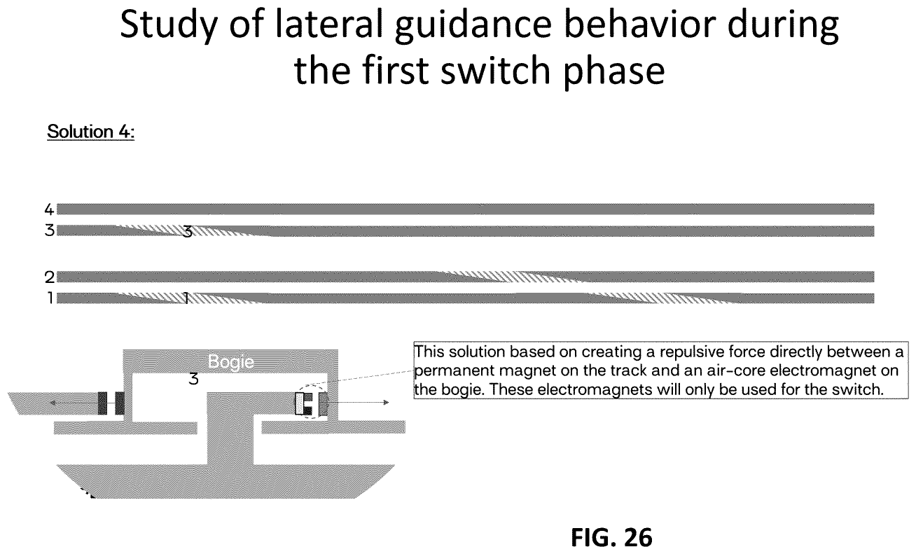

Another solution illustrated in FIG. 25 suggests making no modifications to the system and relying solely on the centrifugal force during the switching process. To accommodate this, the switch for both directions 1 and 2 should be curved rather than straight. The solution in FIG. 26 involves placing permanent magnets on track number 2 and using air-core electromagnets (coils) on the bogie. These electromagnets are controlled to create a magnetic field opposite to that of the permanent magnets on the track, generating a repulsive force. These electromagnets will only be used during the switching process.

### Transition Curve and Discontinuities in Tracks

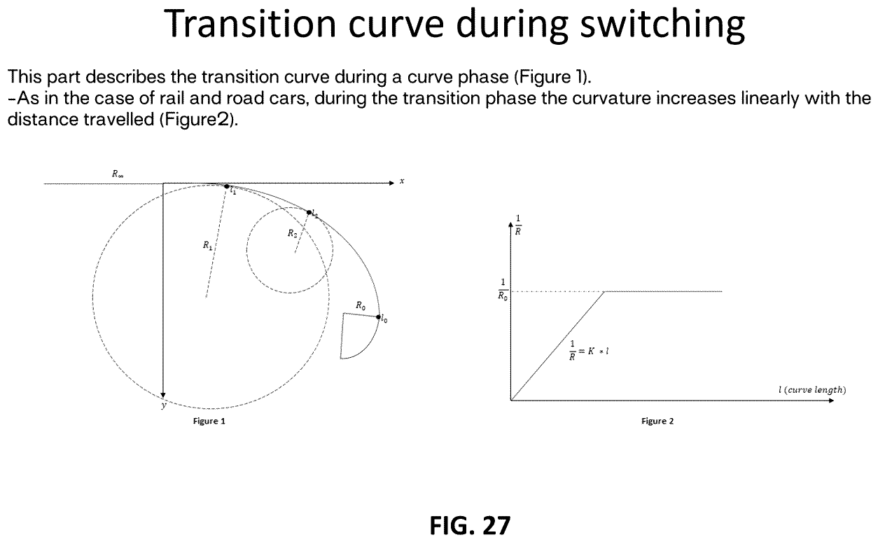

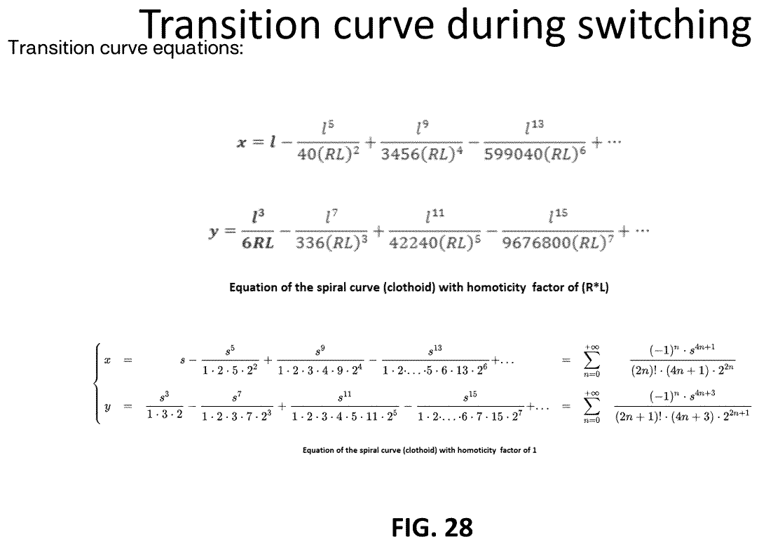

FIG. 27 illustrates the transition curve during a curve phase. As with rail and road vehicles, the curvature increases linearly with the distance traveled during the transition phase. The equations in FIG. 28 depict the formula for the so-called spiral or clothoid curve during the switching phase.

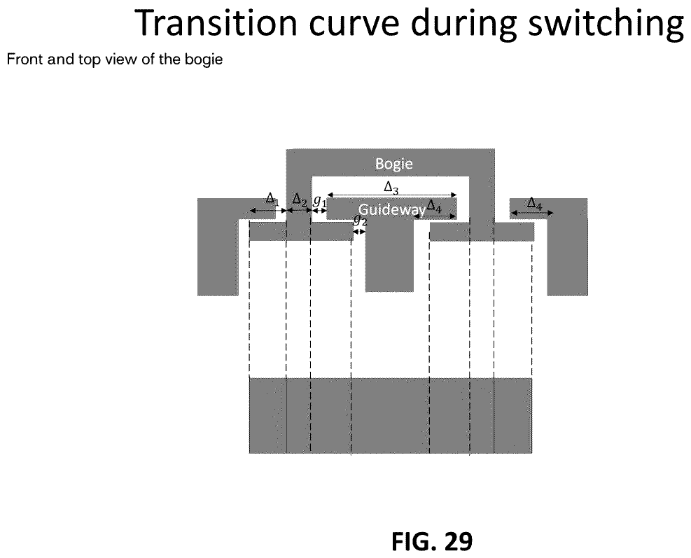

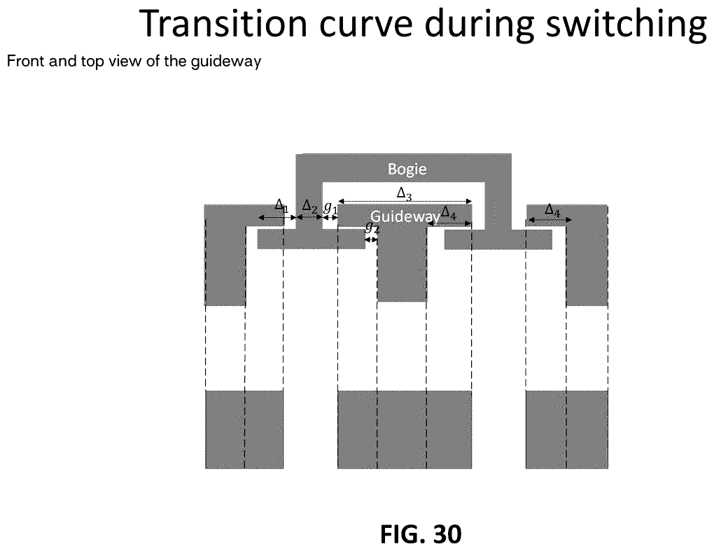

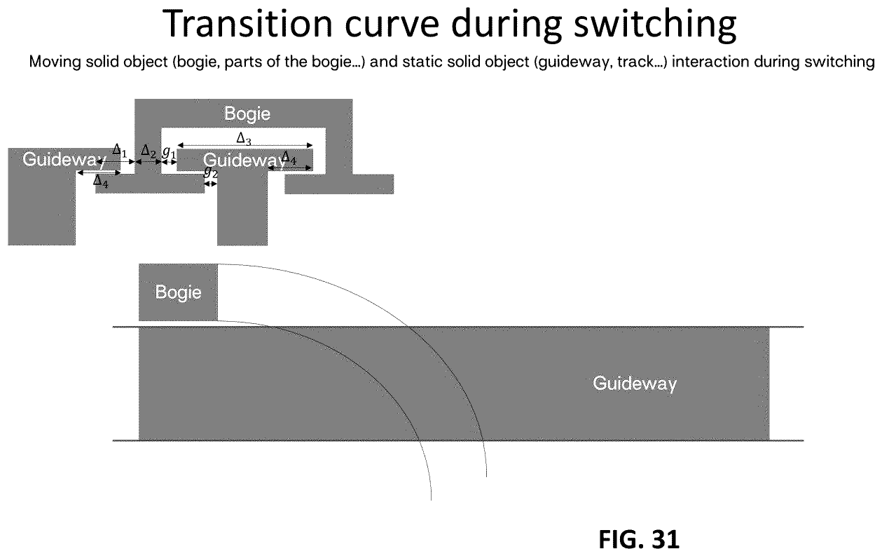

FIGS. 29 and 30 provide front and top views of the bogie and guideway, respectively, with the relevant dimensions illustrated. FIG. 31 depicts a typical scenario showing the interaction between moving solid objects (such as the bogie and its components) and static solid objects (such as the guideway and track) during switching.

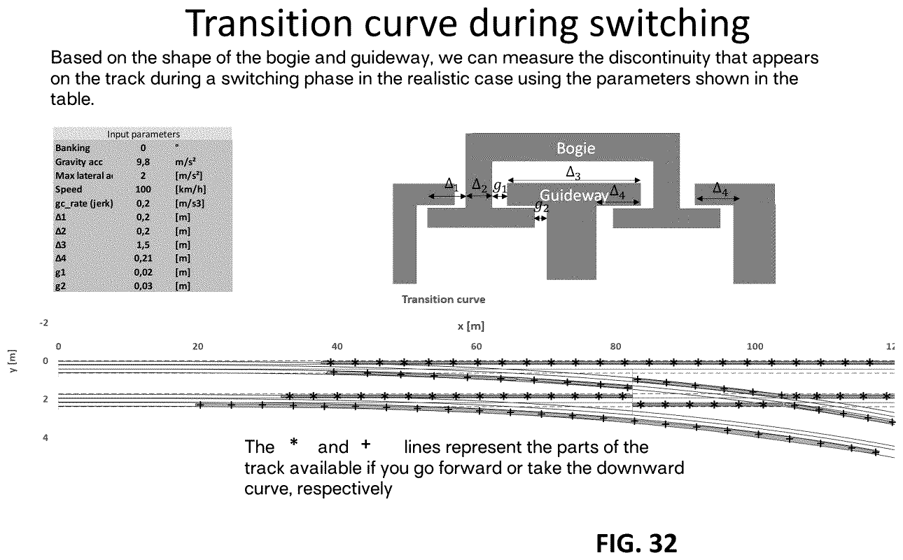

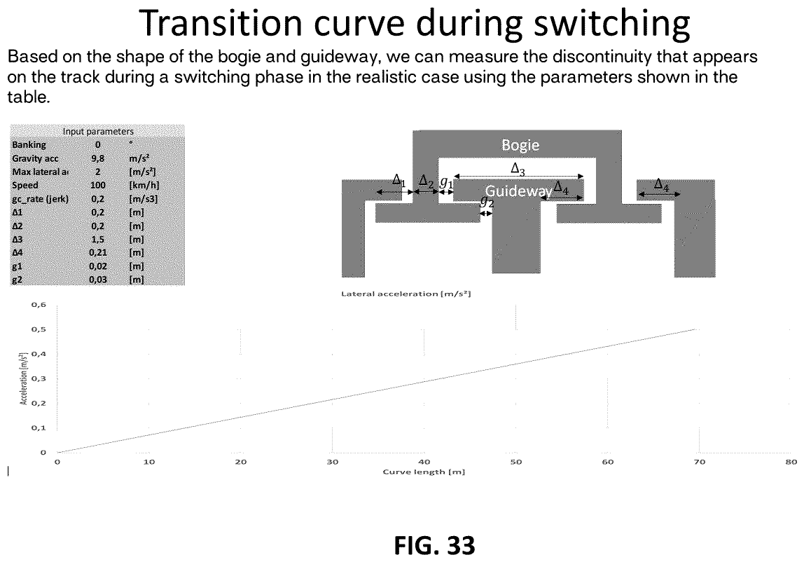

In FIG. 32, we can assess the discontinuity that appears on the track during the switching phase based on the shape of the bogie and guideway, using the parameters presented in the table. The blue (*) lines and green (+) lines indicate the sections of track that could be utilized for levitation if the capsule takes direction 1 or direction 2, respectively. Finally, FIG. 33 shows the acceleration as a function of the distance traveled on the transition curve during switching, using typical parameters.

### Global View and Mechanical Integration of the PLG Concepts

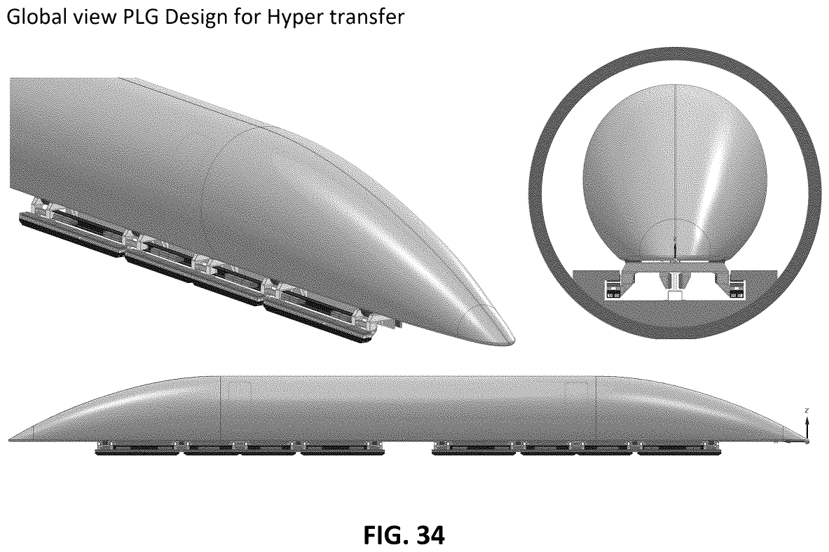

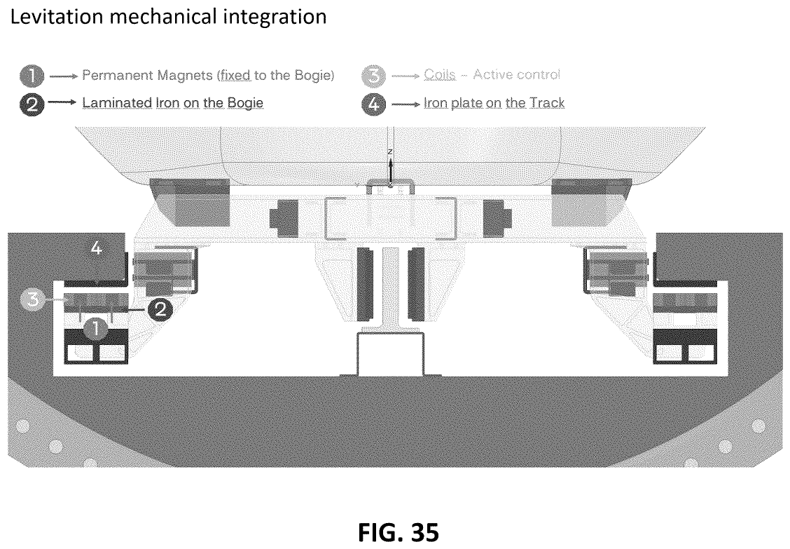

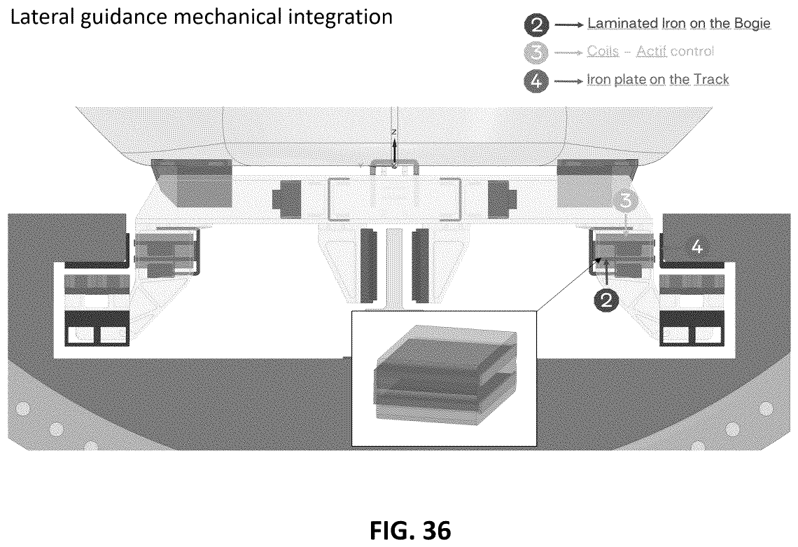

FIGS. 34, 35, and 36 provide a global view and mechanical integration of the PLG concepts. FIG. 34 depicts a front view of the capsule inside a tube and some 3D view of the capsule. FIG. 35 illustrates the mechanical integration of the levitation system, while FIG. 36 presents the mechanical integration of the guidance system. All the active elements are represented in the last two figures.

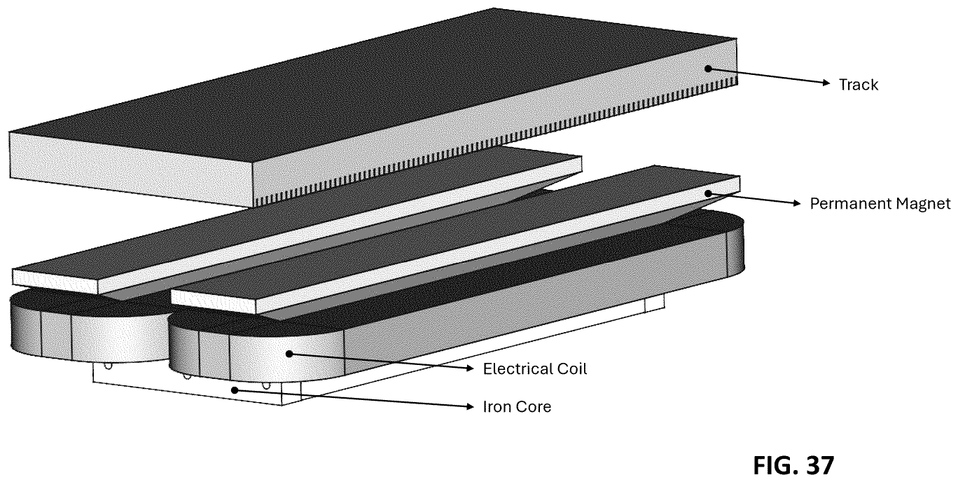

FIG. 37 illustrates the active components of a hybrid levitation system. The iron track represents the reactive iron plate with which the levitation pad interacts through an attractive force. The track is made of standard solid iron. The levitation pad is composed of permanent magnets, which create the static attraction force necessary to ensure levitation. The permanent magnet material is made of NdFeBr N42 UH. Electrical coils are used to control the levitation force by either strengthening or weakening the static attraction force generated by the permanent magnets. The electrical coil is made by Aluminum to reduce levitation pad mass. The iron core's role is to guide the magnetic flux. The iron core is made by Iron Cobalt high magnetic propriety material.

In this invention, various technical methods designed to reduce losses in this hybrid magnetic levitation technology are presented. Specifically, Joule losses in the coils, iron losses in the iron core, and eddy current losses in the iron track can be significant if certain technical details are not carefully considered. Therefore, outlined herein are several techniques that reduce these losses, leading to a hybrid levitation module with low losses and a very high lift-to-drag ratio.

### Magnet Thickness and Reduction of Joules Losses on the Coil and Eddy Current Losses on the Track

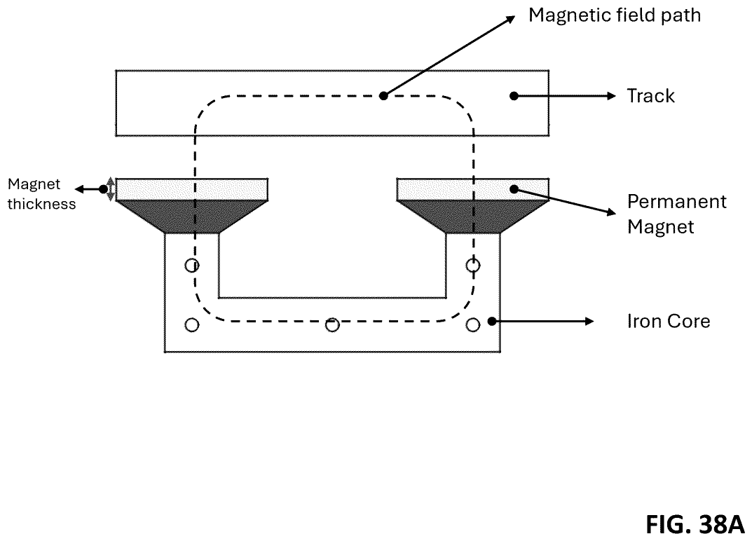

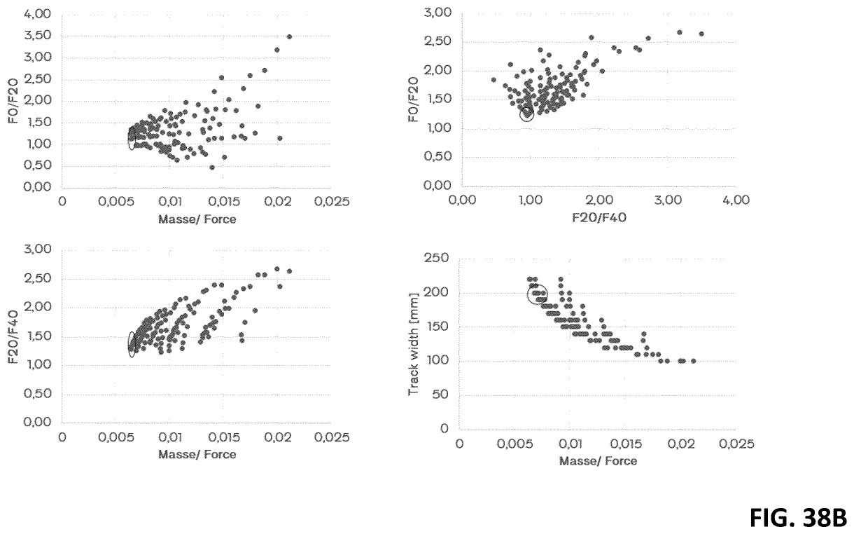

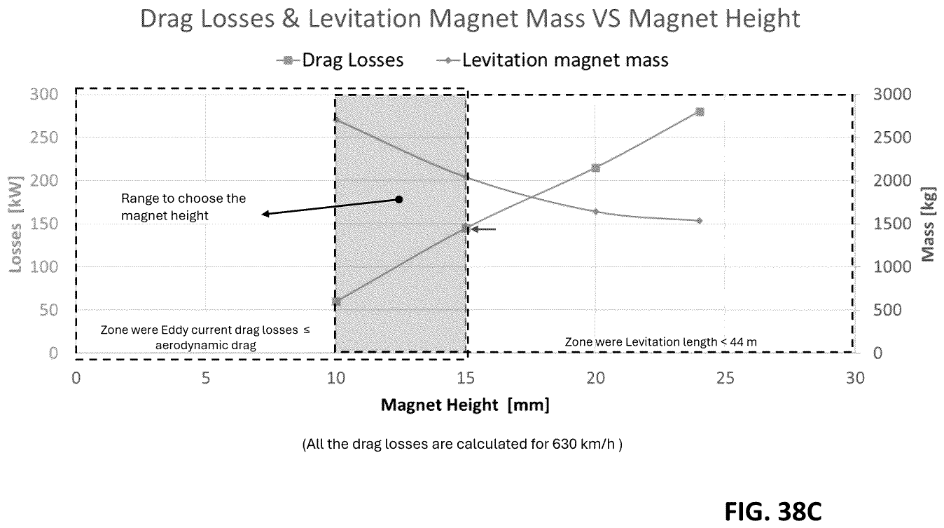

In FIG. 38A, we can observe a front view of the levitation pad, the permanent magnet are attached to the iron core and positioned in front of the iron track at the nominal airgap value of 20 mm (the airgap is the distance between the surface of the magnet and the inner surface of the track). The path of the magnetic field is also shown. Due to the high magnetic permeability of the iron, the magnetic field encounters little resistance when passing through the iron parts (track and iron core). However, it faces significant resistance when passing through the permanent magnet and the airgap, as their magnetic permeability is close to that of a vacuum. Therefore, reducing the thickness of the permanent magnets helps shorten the path of the magnetic field. This reduction contributes to lowering the current effort required in the electrical coils to produce the same effect. During the optimization process of the levitation module, this current effort is considered as a cost function to be minimized. FIG. 38B shows the results of the optimization.

During the optimization the following parameters are varied: magnet width, magnet height, distance between magnets.

The cost functions used in the optimization process are as follows:
Mass/Force: The ratio of the levitation pad mass to the levitation force.
Track width: The width of the track.
F20/F40: The ratio of the force at a 20 mm airgap and zero current in the coil to the force at a 40 mm airgap and 10 A/mm² current density in the coils.
F0/F20: The ratio of the force at a 0 mm airgap and −10 A/mm² current density to the force at a 20 mm airgap and zero current in the coil.

To control the airgap, during normal operation, the control current is used to maintain a constant nominal airgap of 20 mm. If the airgap increases (>20 mm), a positive current will be injected into the coils to strengthen the magnetic field of the magnets and generate more force, bringing the airgap back to 20 mm. Conversely, if the airgap decreases (<20 mm), a negative current will be injected to reduce the magnetic field of the permanent magnets and decrease the attractive force, bringing the airgap back to 20 mm.

These two functions measure the ability of the current in the coils to increase or decrease the magnetic field of the magnets, in other words, they measure the current effort. The 0 mm and 40 mm airgaps, as well as −10 A/mm² and +10 A/mm² current densities, represent extreme cases of variations in the airgap and control current.

The reduction in current effort naturally leads to a decrease in Joule losses in the electrical coils, as this current effort directly correlates with the Joule losses in the coils. The optimization process results in a levitation design with thin magnet. The blue circle in FIG. 38B highlights the most interesting configurations (minimizing the cost functions).

Once an optimal design is selected from the previous optimization process, additional parameters are considered to finalize the design. In fact, thinner magnets lead to a lower magnetic flux density in the airgap, which helps reduce eddy current losses in the track. As shown in the literature, these eddy current losses depend on the square of the flux density in the airgap.

FIG. 38C illustrates the impact of magnet height on both levitation mass and drag losses. It clearly shows that a thinner magnet reduces drag losses. To determine an appropriate range for magnet height, we must also consider another parameter—the total length of the levitation modules—which increases as magnet height decreases.

If we impose the constraint that magnetic drag losses should be equal to or lower than aerodynamic drag losses, and the maximum allowable length of the levitation pads is approximately 44 m (the available space on the capsule's bogies), then:
At a magnet height of 15 mm, magnetic drag losses of 150 KW are comparable to the aerodynamic drag of the capsule at a partial vacuum of 50 pascals and 630 km/h.
At a magnet height of 10 mm, the total length of the levitation pads remains around 44 m (22 m per side), which fits within the available space on the bogies. The levitation mass accounts for approximately 7.5% of the total capsule mass of 36 T.

Therefore, a magnet height range between 10 mm and 15 mm is optimal, balancing both drag losses and total levitation mass.

### Using a Combination Solid/Laminated Iron Core for Reduction of the Iron Losses

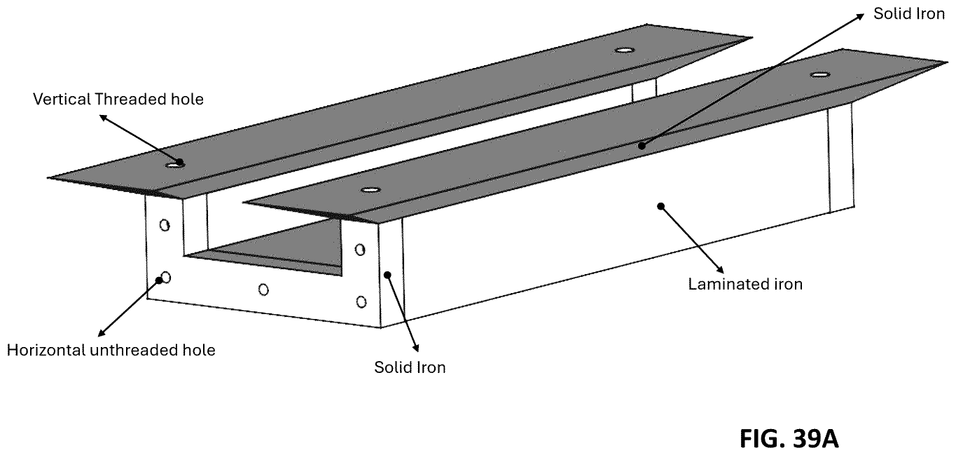

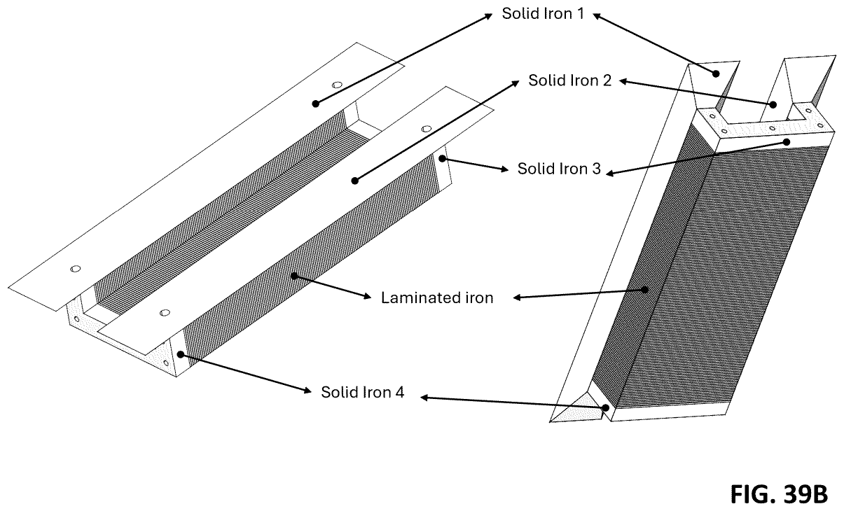

The goal is to minimize iron losses, which are very low in the laminated iron and high in the solid iron. However, from a mechanical point of view, laminated iron, formed by stacked iron sheets, cannot achieve the shape shown in the FIGS. 39A and 39B on its own. Therefore, a combination of solid and laminated iron parts is used to reduce the iron losses in the iron core of the hybrid active-passive levitation system. As shown in the figure, the different parts are distinguished, and holes are visible for assembling the laminated iron with the solid iron parts. Solid iron 1 and solid iron 2 are fixed to solid iron 3 and solid iron 4 with screws that pass through vertical threaded holes. The laminated iron part is attached to the solid iron 3 and solid iron 4 using bolts that go through horizontal holes, securing the laminated iron between the two solid iron parts. FIG. 39B shows the U-shaped laminated iron part.

### Design of the Iron Core to Minimize Eddy Current Losses in The Iron Track

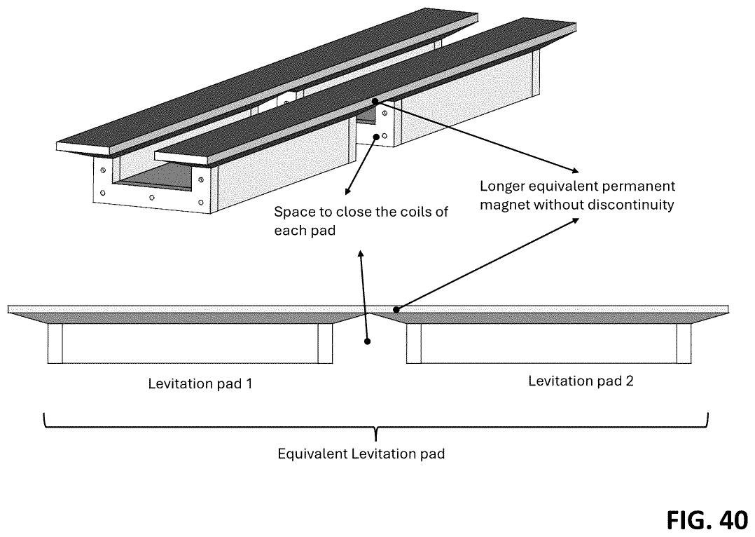

Eddy current losses in the iron track are generated due to the end effects of the magnetic field created by the levitation module. In fact, the homopolar configuration of the magnetic field in the levitation pad results in a constant magnetic field along the direction of motion, which theoretically leads to zero eddy current losses. However, the discontinuities in the magnetic field caused by the end effects can create significant eddy current losses. To minimize these losses, it is important to reduce the gaps between the magnets as much as possible. One possible solution would be to use very long levitation modules, but this would be challenging from a manufacturing, transportation, and installation perspective. FIG. 40 illustrates two levitation pads placed side by side, where the design of the iron core ensures the continuity of the permanent magnets. This allows us to form an equivalent longer module by using smaller modules while maintaining magnetic continuity. At the same time, the design of the iron core allows the coil to close for each module.

### Grooves in the Iron Track to Minimize Eddy Current Losses in the Iron Track

The use of a solid iron track is an attractive solution for the homopolar levitation configuration, as it is more cost-effective than laminated iron. However, its main drawback is the high eddy current losses.

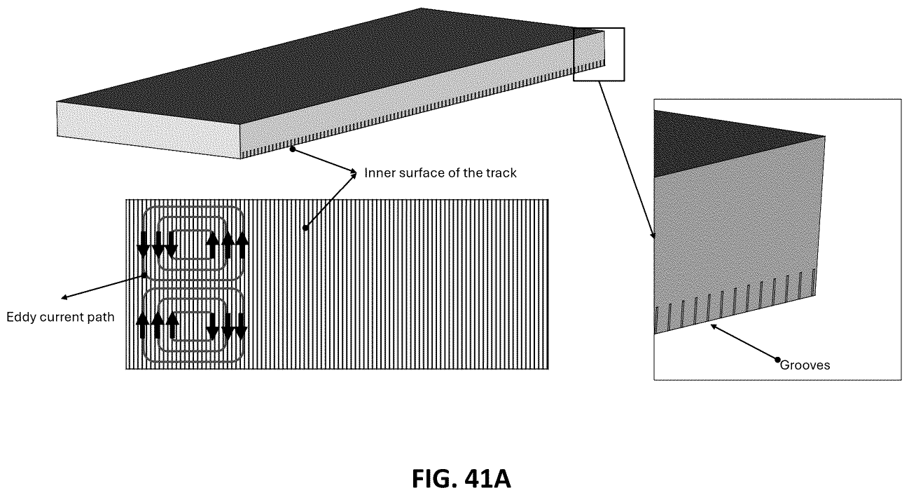

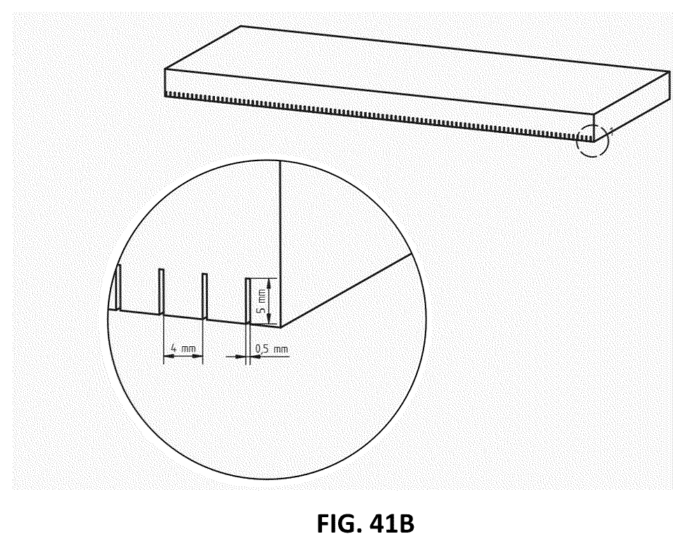

A method to minimize these losses is to incorporate grooves on the inner surface of the track. These grooves help reduce eddy currents by guiding them in specific directions to encourage their cancellation. As shown in FIG. 41A, the eddy currents caused by the end effect form two opposing current loops. The grooves facilitate mutual cancellation of these loops rather than allowing them to close independently. This is why the grooves are oriented transversely to the motion.

It is important to note that longitudinal grooves would also reduce eddy currents, but for a different reason. In this case, the grooves interrupt the current path, a technique commonly used in high-power solid-pole generators.

The orientation of the grooves in the transversal direction is simpler to manufacture.

FIG. 41B shows the dimensions of the grooves.

### Magnet Orientation to Reduce End Effect

As mentioned earlier, minimizing the gap between the magnets of the levitation pads is essential to reduce the end effect. However, some discontinuities are unavoidable.

In our application, which involves the magnetic levitation of a capsule-based transportation system, multiple bogies can move independently. To allow this movement, there will inevitably be discontinuities in the levitation modules. In other words, the end effect is inherent to the system and must be managed.

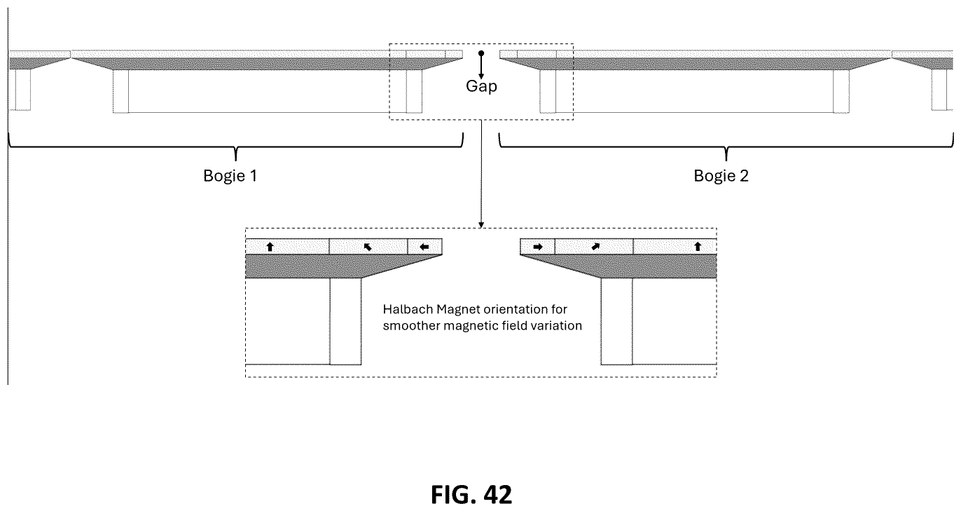

One way to reduce eddy current losses is to smooth the variation of the magnetic field, making it less abrupt. FIG. 42 presents a solution that involves adjusting the orientation of the permanent magnets in the levitation pads at these gaps. A configuration similar to a Halbach array is applied to the magnets, leading to a smoother magnetic field transition and, consequently, a reduction in eddy current losses.

### Finite Element Results

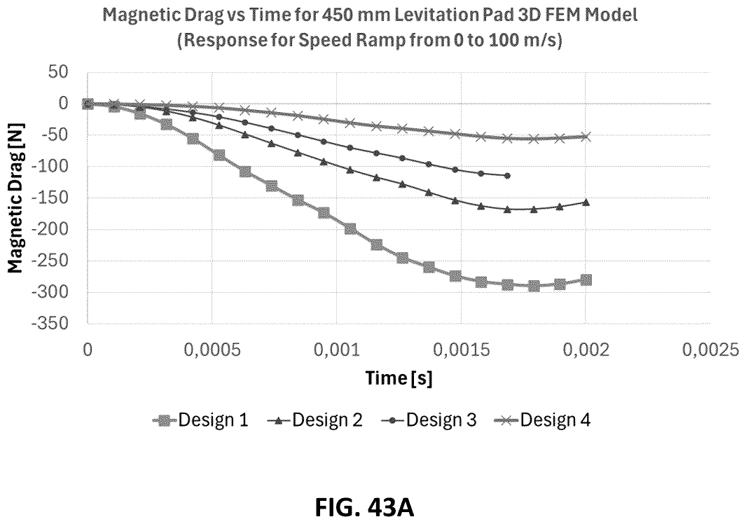

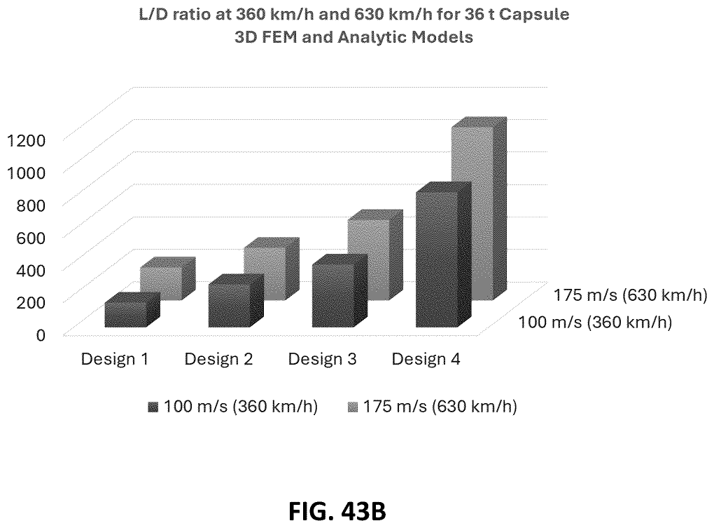

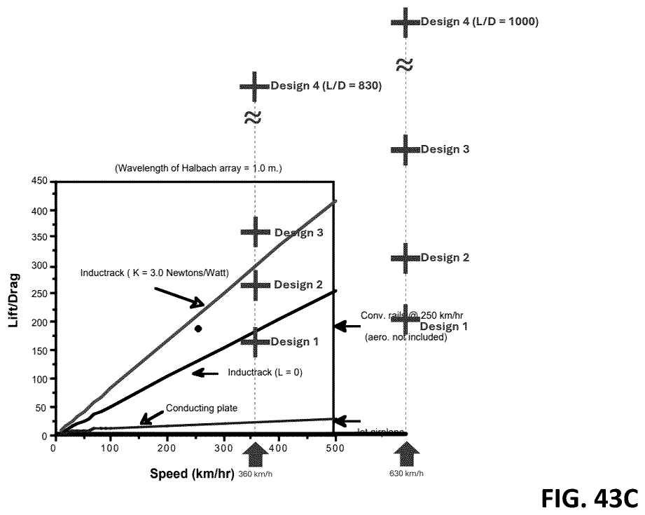

FIG. 43A presents the finite element results analyzing the impact of magnet height, magnet orientation, and grooves on reducing the magnetic drag force caused by eddy current losses.

FIG. 43B illustrates the effect of these parameters on the lift-to-drag ratio at 360 km/h and 650 km/h. From FIG. 43C, we can observe the performance improvement of our technology in terms of lift-to-drag ratio compared to other technologies at 360 km/h and 650 km/h. The following table gives the parameters value for each design.

| | | Orientation of the | |
|---|---|---|---|
| | Magnet | magnet at the | |
| | high | discontinuity | Grooves |
| Design 1 | 15 mm | Normal | No |
| Design 2 | 15 mm | Halbach | No |
| Design 3 | 15 mm | Halbach | Yes |
| Design 4 | 10 mm | Halbach | Yes |

The above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor. By way of example, and not limitation, such non-transitory computer-readable media can include flash memory, RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. The computer readable media does not include carrier waves and electronic signals passing wirelessly or over wired connections.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase, for example, an “aspect” does not imply that the aspect is essential to the subject technology or that the aspect applies to all configurations of the subject technology. A disclosure relating to an aspect may apply to all configurations, or one or more configurations. A phrase, for example, an aspect may refer to one or more aspects and vice versa. A phrase, for example, a “configuration” does not imply that such configuration is essential to the subject technology or that such configuration applies to all configurations of the subject technology. A disclosure relating to a configuration may apply to all configurations, or one or more configurations. A phrase, for example, a configuration may refer to one or more configurations and vice versa.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As noted above, particular embodiments of the subject matter have been described, but other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

### CONCLUSION

A system and method have been shown in the above embodiments for the effective implementation of a novel propulsion, levitation, guidance and levitation system and method. While various preferred embodiments have been shown and described, it will be understood that there is no intent to limit the invention by such disclosure, but rather, it is intended to cover all modifications falling within the spirit and scope of the invention, as defined in the appended claims.

What is claimed is:

1. A bogie side propulsion, guidance and levitation system comprising:
a. an air core linear synchronous motor comprising:
i. a first back iron with a first set of multipolar permanent magnets affixed to a backside of the first back iron;
ii. a second back iron with a second set of multipolar permanent magnets affixed to a backside of the second back iron;
wherein the first back iron and the second back iron are attached to an underside of a bogie with the first set of multipolar magnets opposing the second set of multipolar magnets with an air gap formed in between them, and wherein polarity of permanent magnets in each opposing section of the first back iron and the second back iron is aligned in a similar direction to ensure proper magnetic flux orientation;
b. a lateral guidance system comprising a plurality of electromagnets, each of the plurality of electromagnets comprising a U-shaped metal core with each post in the U-shaped metal core having a coil wound thereon;
c. a hybrid active-passive levitation system comprising:
i. a plurality of homopolar permanent magnets;
ii. a iron core,
wherein two parallel rows of homopolar permanent magnets are aligned along a direction of capsule movement, with all homopolar magnets within the same row maintain a similar polarity, while two opposing rows have opposite polarities, with a magnetic field flowing from one row to the other, passing through the air gap, an iron track, and the iron core.

2. The bogie side propulsion, guidance and levitation system of claim 1, wherein the bogie side propulsion, guidance and levitation system is implemented in a partial vacuum tunnel.

3. The bogie side propulsion, guidance and levitation system of claim 1, wherein either the first set of multipolar permanent magnets or the second set of multipolar permanent magnets, or a combination thereof, comprises Neodymium-Iron-Boron (NdFeB) magnets.

4. The bogie side propulsion, guidance and levitation system of claim 1, wherein either the first set of multipolar permanent magnets or the second set of multipolar permanent magnets, or a combination thereof, comprises Samarium-Cobalt (SmCo) magnets.

5. The bogie side propulsion, guidance and levitation system of claim 1, wherein the U-shaped metal core is a iron core.

6. The bogie side propulsion, guidance and levitation system of claim 1, wherein the coil wound on the U-shaped iron core is made from copper.

7. The bogie side propulsion, guidance and levitation system of claim 1, wherein the coil wound on the U-shaped iron core is made from Aluminum.

8. The bogie side propulsion, guidance and levitation system of claim 1, wherein a total number of the plurality of electromagnets is picked based on the mass of the capsule.

9. The bogie side propulsion, guidance and levitation system of claim 1, wherein the hybrid active-passive levitation system is embedded in epoxy resin.

10. A track side propulsion, guidance, and levitation system comprising:
a. an air core linear synchronous motor stator comprising:
i. a plurality of three-phase coils, and
ii. an epoxy resin structure embedding the three-phase coils,
wherein the three-phase coils are configured to generate a traveling electromagnetic field that interacts with a bogie-mounted set of multipolar permanent magnets to propel the vehicle;
b. a lateral guidance track portion comprising a first ferromagnetic track, wherein the first ferromagnetic track is configured to interact with a bogie-mounted plurality of electromagnets to provide lateral guidance; and
c. a levitation track portion comprising a second ferromagnetic beam arranged substantially horizontally, wherein the second ferromagnetic beam is configured to interact with a bogie-mounted hybrid active-passive levitation system to provide lift.

11. The track side propulsion, guidance, and levitation system of claim 10, wherein the track side propulsion, guidance, and levitation system is implemented in a partial vacuum tunnel.

12. The track side propulsion, guidance, and levitation system of claim 10, wherein the three-phase coils of the air core linear synchronous motor stator are arranged in a single-turn configuration to simplify manufacturing and reduce overall system cost.

13. The track side propulsion, guidance, and levitation system of claim 10, wherein each of the plurality of three-phase coils of the air core linear synchronous motor stator is made from copper.

14. The track side propulsion, guidance, and levitation system of claim 10, wherein each of the plurality of three-phase coils of the air core linear synchronous motor stator is made from aluminum.

15. The track side propulsion, guidance, and levitation system of claim 10, wherein the lateral guidance track portion and the levitation track portion are integrated together to form an L-shaped cross section, simplifying the structural design.

16. The track side propulsion, guidance, and levitation system of claim 10, wherein the first ferromagnetic track in the lateral guidance track portion and the second ferromagnetic track in the levitation track portion both comprise solid iron.

17. The track side propulsion, guidance, and levitation system of claim 10, wherein the plurality of three-phase coils in the air core linear synchronous motor stator is distributed along a track in segments, each segment energizable independently based on a position of the capsule to optimize energy usage.

18. The track side propulsion, guidance, and levitation system of claim 10, wherein the epoxy resin structure provides mechanical support and environmental protection to the plurality of three-phase coils, preserving precise coil positioning and mitigating vibrational effects during high-speed operation.

19. A method of levitating, propelling, and guiding a capsule traveling along a track in at least a partial vacuum tunnel, the method comprising:
a. generating a propulsive force by supplying a three-phase current to a plurality of three-phase coils embedded in an epoxy resin structure on the track side, thereby creating a traveling electromagnetic field in an air core linear synchronous motor stator;
b. interacting the magnetic fields of the traveling electromagnetic field with at least a first set of multipolar permanent magnets and a second set of multipolar permanent magnets affixed to respective back irons on an underside of a bogie, wherein each set of multipolar permanent magnets opposes the other across an air gap, causing a propulsive force on the bogie;
c. providing lateral guidance by energizing a plurality of electromagnets on the bogie side, each of the plurality of electromagnets comprising a U-shaped metal core with a coil wound on each post, to induce electromagnetic attraction with a first ferromagnetic track portion arranged substantially vertically, thereby controlling lateral positioning of the capsule;
d. establishing hybrid active-passive levitation by arranging two parallel rows of homopolar permanent magnets of similar polarity within each row and opposite polarities between rows, wherein each row is affixed to an iron core on the bogie, and interacting said rows with a second ferromagnetic track portion arranged substantially horizontally, such that the weight of the capsule is supported by magnetic forces and selectively modulated by energizing one or more coils adjacent to the homopolar permanent magnets; and
e. maintaining air gaps between the bogie-mounted permanent magnets or electromagnets and the respective ferromagnetic track portions, wherein sensors monitor the air gaps, and a control system adjusts current in the three-phase coils or the electromagnet coils to ensure stable propulsion, guidance, and levitation throughout capsule travel.
